(19) United States
(12) Patent Application Publication
(10) Pub. No.: US 2023/0206119 A1
(43) Pub. Date: Jun. 29, 2023

(54) EVENT MODEL TRAINING USING IN SITU DATA

(71) Applicant: LYTT LIMITED, Middlesex (GB)

(72) Inventors: Cagri CERRAHOGLU, London (GB); Pradyumna THIRUVENKATANATHAN, Twickenham, London (GB)

(73) Assignee: LYTT LIMITED, Middlesex (GB)

(21) Appl. No.: 17/925,575

(22) PCT Filed: Jun. 18, 2020
(86) PCT No.: PCT/EP2020/067044

§ 371 Date: Nov. 15, 2022

(51) Int. Cl. G06N 20/00

(52) U.S. Cl. CPC G06N 20/00

(57) ABSTRACT

A method of identifying events comprises obtaining a first set of measurements comprising a first signal of field data at a location; identifying one or more events at the location using the first set of measurements; obtaining a second set of measurements comprising a second signal at the location, wherein the first signal and the second signal represent at least one different physical measurements; training one or more event models using the second set of measurements and the identification of the one or more events as inputs; and using the one or more event models to identify at least one additional event at one or more locations.

### CROSS-REFERENCE TO RELATED APPLICATIONS

This application is a 35 U.S.C. § 371 national stage application of PCT/EP2020/067044 filed Jun. 18, 2020, entitled “Event Model Training Using in Situ Data,” which is hereby incorporated herein by reference in its entirety for all purposes.

### STATEMENT REGARDING FEDERALLY SPONSORED RESEARCH OR DEVELOPMENT

Not applicable.

### BACKGROUND

It can be desirable to identify various events in a variety of settings. For example, events can be identified at a location or premises, along various pathways, or events associated with equipment of devices. Identifying events often requires information for a known instance of the event, which may not always be available, and even when available, may not match information for the event in different settings.

### BRIEF SUMMARY

In some embodiments, a method of identifying events comprises: obtaining a first set of measurements comprising a first signal of field data at a location; identifying one or more events at the location using the first set of measurements; obtaining a second set of measurements comprising a second signal at the location, wherein the first signal and the second signal represent at least one different physical measurements; training one or more event models using the second set of measurements and the identification of the one or more events as inputs; and using the one or more event models to identify at least one additional event at one or more locations.

In some embodiments, a system for identifying events comprises: a memory; an identification program stored in the memory; and a processor, wherein the identification program, when executed on the processor, configures the processor to: receive a first set of measurements comprising a first signal of field data at a location; identify one or more events at the location using the first set of measurements; receive a second set of measurements comprising a second signal at the location, wherein the first signal and the second signal represent at least one different physical measurements; train one or more event models using the second set of measurements and the identification of the one or more events as inputs; and use the one or more event models to identify at least one additional event at one or more locations.

In some embodiments, a method of identifying events comprises: obtaining a first set of measurements comprising a first signal of field data at a location; identifying one or more events at the location using the first set of measurements; obtaining an acoustic data set at the location, wherein the first signal is not an acoustic signal; training one or more event models using the acoustic data set and the identification of the one or more events as inputs; and using the trained one or more event models to identify at least one additional event at the location or a second location.

In some embodiments, a system for identifying events comprises: a memory; an identification program stored in the memory; and a processor, wherein the identification program, when executed on the processor, configures the processor to: receive a first set of measurements comprising a first signal of field data at a location; identify one or more events at the location using the first set of measurements; obtain an acoustic data set at the location, wherein the first signal is not an acoustic signal; train one or more event models using the acoustic data set and the identification of the one or more events as inputs; and use the trained one or more event models to identify at least one additional event at the location or a second location.

In some embodiments, a method of identifying events comprises: obtaining a first set of measurements comprising a first signal of field data across a plurality of locations; identifying one or more events at one or more locations of the plurality of locations using the first set of measurements; obtaining a second set of measurements comprising a second signal across the plurality of locations, wherein the first signal and the second signal represent at least one different physical measurements; training one or more event models using the second set of measurements at the one or more locations of the plurality of locations and the identification of the one or more events as inputs; and using the one or more event models to identify at least one additional event across the plurality of locations.

In some embodiments, a system for identifying events comprises: a memory; an identification program stored in the memory; and a processor, wherein the identification program, when executed on the processor, configures the processor to: receive a first set of measurements comprising a first signal of field data across a plurality of locations; identify one or more events at one or more locations of the plurality of locations using the first set of measurements; obtain a second set of measurements comprising a second signal across the plurality of locations, wherein the first signal and the second signal represent at least one different physical measurements; train one or more event models using the second set of measurements at the one or more locations of the plurality of locations and the identification of the one or more events as inputs; and use the one or more event models to identify at least one additional event across the plurality of locations.

Embodiments described herein comprise a combination of features and characteristics intended to address various shortcomings associated with certain prior devices, systems, and methods. The foregoing has outlined rather broadly the features and technical characteristics of the disclosed embodiments in order that the detailed description that follows may be better understood. The various characteristics and features described above, as well as others, will be readily apparent to those skilled in the art upon reading the following detailed description, and by referring to the accompanying drawings. It should be appreciated that the conception and the specific embodiments disclosed may be readily utilized as a basis for modifying or designing other structures for carrying out the same purposes as the disclosed embodiments. It should also be realized that such equivalent constructions do not depart from the spirit and scope of the principles disclosed herein.

### BRIEF DESCRIPTION OF THE DRAWINGS

For a detailed description of various exemplary embodiments, reference will now be made to the accompanying drawings in which:

FIG. 1A is a flow diagram of a method for identifying events according to some embodiments;

FIG. 1B is a flow diagram of a method for identifying events according to some embodiments;

FIG. 1C is a flow diagram of a method for identifying events according to some embodiments;

FIG. 2 is a flow diagram of a method of identifying one or more events at a location using a first set of measurements according to some embodiments;

FIG. 3 is a schematic illustration of an environment or premises with which the system and method of this disclosure can be utilized according to some embodiments; and

FIG. 4 schematically illustrates a computer that may be used to carry out various methods according to some embodiments.

### DETAILED DESCRIPTION

The following discussion is directed to various exemplary embodiments. However, one of ordinary skill in the art will understand that the examples disclosed herein have broad application, and that the discussion of any embodiment is meant only to be exemplary of that embodiment, and not intended to suggest that the scope of the disclosure, including the claims, is limited to that embodiment.

The drawing figures are not necessarily to scale. Certain features and components herein may be shown exaggerated in scale or in somewhat schematic form and some details of conventional elements may not be shown in interest of clarity and conciseness.

Unless otherwise specified, any use of any form of the terms “connect,” “engage,” “couple,” “attach,” or any other term describing an interaction between elements is not meant to limit the interaction to direct interaction between the elements and may also include indirect interaction between the elements described. In the following discussion and in the claims, the terms “including” and “comprising” are used in an open-ended fashion, and thus should be interpreted to mean “including, but not limited to . . . ”. Reference to up or down will be made for purposes of description with “up,” “upper,” “upward,” “upstream,” or “above” meaning toward the end of an optical fiber closest to a source and/or receiver and with “down,” “lower,” “downward,” “downstream,” or “below” meaning toward the terminal end of the fiber, regardless of the fiber orientation. The various characteristics mentioned above, as well as other features and characteristics described in more detail below, will be readily apparent to those skilled in the art with the aid of this disclosure upon reading the following detailed description of the embodiments, and by referring to the accompanying drawings.

As used herein, the term acoustic signals refers to signals representative of measurements of acoustic sounds, dynamic strain, vibrations, and the like, whether or not within the audible or auditory range.

Disclosed herein are systems and methods for identifying events, for example, so that an operator may more effectively control an operation. According to embodiments of this disclosure, an event associated with an operation can be identified, and data corresponding to the event can be obtained and used to provide training data for one or more event models. The event can be identified in a number of ways including inducing or having a known, local event, and/or using one or more sensors that are different from the obtained data to provide information to identify the event. For example, passing a known vehicle through a security checkpoint can be used to induce a known event (e.g., vehicular traffic), or powering up a piece of equipment such as a pump can serve to induce a known event (e.g., operating a pump). Data from sensors within a security perimeter or within an equipment monitoring system, respectively, during the induced event can then be used to provide training data for a corresponding event model (e.g., a vehicular traffic model, a pump operation model, etc.). As another example, a first set of measurements or data of a first signal of field data at a location can be utilized to provide training data for one or more event models, which trained event model(s) can utilize a second set of measurements of a second signal (e.g., of field data) at the location to identify at least one additional event at one or more locations. Utilizing the first set of measurements as a local reference to identify local events allows for the one or more event models to be trained using identified signals. This can help to provide data for training the one or more models that might not otherwise be available, and/or provide data to allow one or more existing models to be calibrated. For example, the one or more event models may be trained using laboratory data and then calibrated using the data obtained during an actual event. Alternatively, the one or more event models may be trained using the field data when laboratory data is not available.

By way of example, in some embodiments, the first set of measurements can comprise temperature features that can be determined from temperature measurements taken along a length being monitored, such as a length of a periphery or perimeter, a length along a pipeline, or a length associated with one or more pieces of equipment (e.g., a pump, turbine, separator, valve, etc.). The temperature measurements can be used in one or more first event models that can provide an output indicative of event location(s), for example, security events along a perimeter. This can allow those locations with the event (e.g., security perimeter breach) to be identified using temperature based measurements (e.g., from the location). When combined with a (e.g., distributed) temperature sensing system that can provide distributed and continuous temperature measurements, the systems can allow for event locations to be tracked through time. In embodiments, various frequency domain features can be obtained from an acoustic signal originating from the event (e.g., along the perimeter). The acoustic signals can be obtained using a distributed acoustic sensing (DAS) system that allows for continuous and distributed acoustic sensing. The acoustic signals can be taken along the same portions of the length (e.g., length of a perimeter) as the temperature measurements, thereby allowing for information about the events (e.g., security events), to be determined using both the temperature features and the frequency domain features. The identification of the event using the temperature measurements can be used to label the acoustic data, and corresponding frequency domain features, to provide a frequency domain feature based training set for one or more second event models. In some embodiments, one or more second event models can be trained with the one or more events identified via the DTS data and corresponding the acoustic measurements obtained based on the event identifications. The resulting trained one or more event models can subsequently be utilized with one or more frequency domain features to identify at least one additional event (e.g., the event identified and used in the model training) at one or more locations along the length.

In aspects, the one or more trained event models can subsequently be utilized alone or together with the one or more first event models, thus allowing the event locations to be determined using various sensor inputs such as acoustic features, temperature features, flow measurements, pressure measurements, position sensor measurements, and the like. The trained one or more event models can be used to verify or validate information (e.g., event locations) as determined from the one or more first event models and/or other sensors. In aspects, the trained one or more event models can be utilized to predict sensor data. The herein disclosed systems and methods can thus help to provide an improved event location determination for use in managing the event.

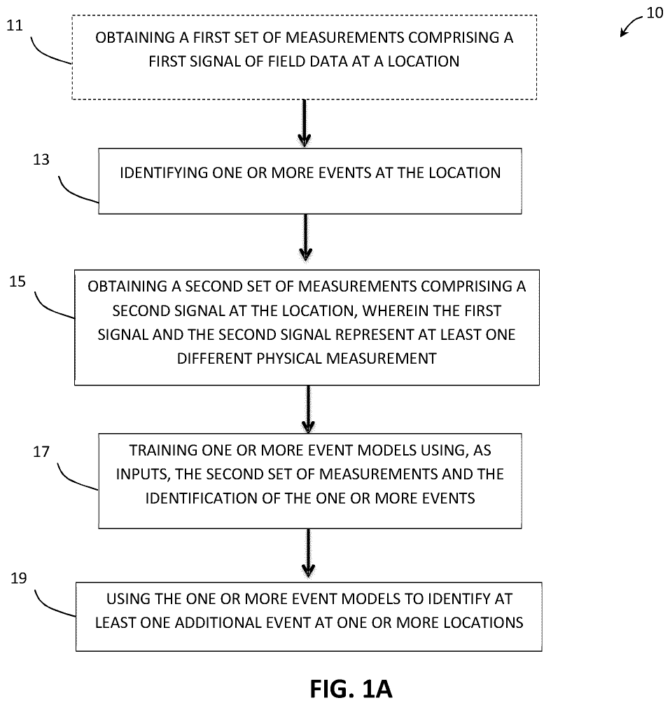

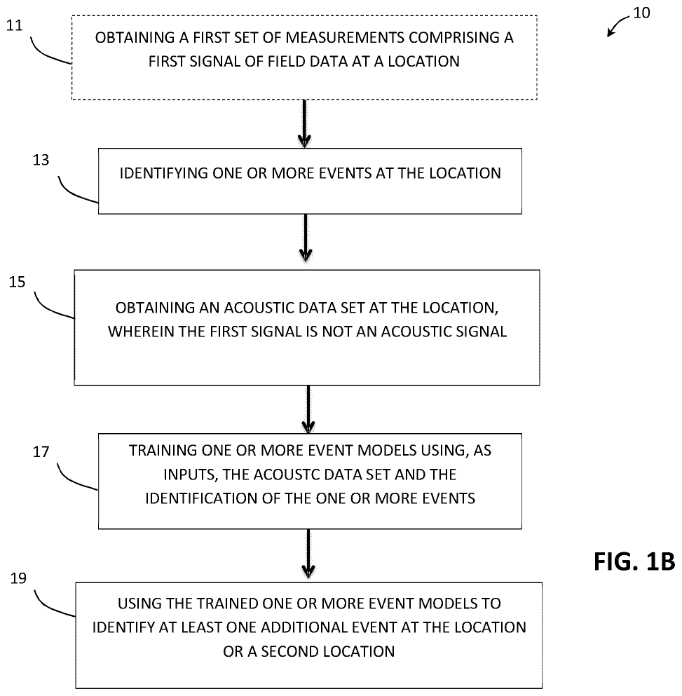

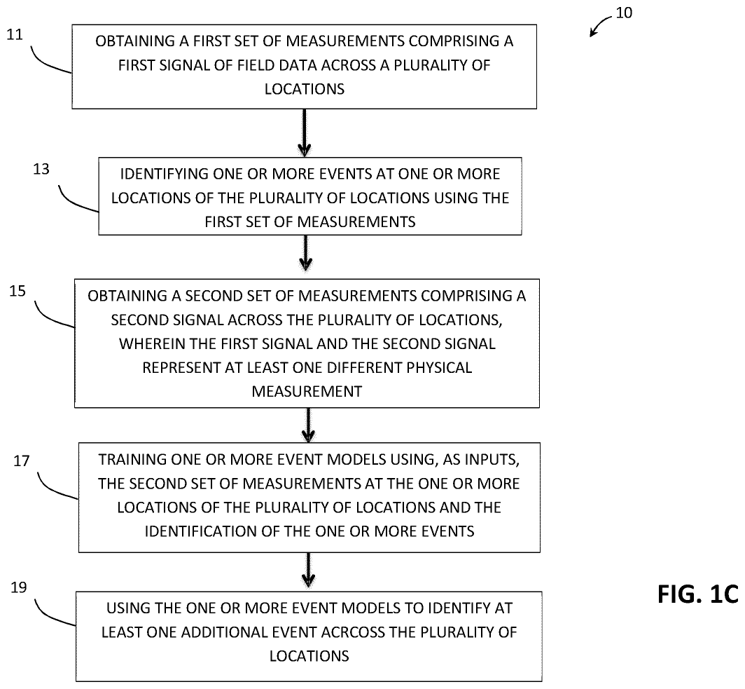

FIG. 1A is a flow diagram of a method 10 for identifying events at a location according to some embodiments. As depicted in FIG. 1A, the method 10 of identifying events at a location can comprise: identifying one or more events at the location at 13; obtaining a second set of measurements comprising a second signal at the location, at 15, wherein the first signal and the second signal represent different physical measurements; training one or more event models using the second set of measurements and the identification of the one or more events as inputs at 17; and using the one or more event models to identify at least one additional event at one or more locations at 19. The one or more events identified at step 13 can be identified using a local or induced event, and/or the one or more events can be identified based on a first set of measurements of a first signal within the wellbore as an optional process at step 11. The first set of measurements and/or the first signal can comprise signals from one or more sensors, and in some aspects, signals from multiple sensors can be used in the identification of the event. When a first set of measurements obtained, the identification of the one or more events can use the first set of measurements and first signal to identify the one or more events within the wellbore at step 13.

The new signal processing architecture disclosed herein allows for the identification of various events at one or more locations. Without limitation, in embodiments, the one or more events identified at 13 can comprise a security event, a transportation event, a geothermal event, a facility monitoring event, a pipeline monitoring event, a dam monitoring event, or any combination thereof. For example, length 120 can be a length about a periphery of a premises 101 comprising a building. In such aspects the system and method can be utilized, for example, for security or facility monitoring. For example, the system and method can be utilized to detect passage of beings (e.g., animals, people), fluids (e.g., liquids), vehicles, or the like into and/or out of the perimeter. Alternatively, the premises can comprise a train track, a pipeline, or a dam, and the length 120 can comprise a length along the train track, the pipeline, or the dam, respectively. In such applications, for example, the disclosed system and method can be utilized to detect passage of a train, beings (e.g., animals, people), fluids (e.g., flooding) at a location(s) along the train track, the pipeline, or the dam. By way of further example, in embodiments, the system and method of this disclosure can be utilized with a premises comprising a section of earth (e.g., from a surface to below a surface of the earth). In such applications, the length can be a length (e.g., a depth) within the earth and the system and method can be utilized to monitor a geothermal event (e.g., passage of fluids (gas, liquid, solid) into or out of the section of earth being monitored. In some aspects, the length can comprise one or more pieces of equipment such as pumps, valves, separators, and the like, and the method can be utilized to monitor the various piece of equipment for different types of events associated with the respective equipment. Numerous other applications of the disclosed system and method will be apparent to those of skill in the art upon reading this disclosure. Such other applications are within the scope of this disclosure.

In some aspects, the one or more events can be identified at step 13 using known operating parameters such as an induced event. Sensor inputs such as operating controls and sensors can be associated with the event that is known or controlled such that an identification of the event may be known and/or one or more parameters of the event (e.g., an extent of the event) may be known. For example, a known security event such as vehicular traffic can be identified or induced (e.g., intentionally created) such that the identification of the event (e.g., vehicular traffic) is occurring at a known location and time, and one or more parameters of the event (e.g., type of vehicle, speed, weight, etc.) may also be known. This information can then be used as the identification of the event that can be used with a second set of measurement associated with the event to provide labeled data for training one or more second event models.

As another example of a known event, a piece of equipment such as a pump or turbine can be operated under various conditions. The rotational speed, power, throughout, and other parameters can be controlled during operation of the equipment. In this example, the event could include rotational equipment operation at a known location and time. The additional parameters such as the operating speed, power, and throughput would also be known based on the sensors and controllers associated with the rotational equipment operation. Thus, a known and/or induced event can be used as the basis for collecting additional sensor information associated with the event and/or one or more event parameters.

In some aspects, the event may not be known, and a first set of measurements can optionally be obtained that have a first signal used to identify the one or more events at step 11. For example, various security intrusions, bearing failures in rotational equipment, pipeline leaks, and the like may occur without being induced. These events may often be transitory and the occurrence of the event (e.g., an identification of the event), its duration, and the extent of the event may not be easily known based on controllable operating parameters. In this instance, the first set of measurements comprising the first signal can be used with one or more first event models to identify the event. The first set of measurements and/or the first signal can comprise signals from one or more sensors, and in some aspects, signals from multiple sensors can be used in the identification of the event. The one or more first event models can comprise any of the models as described herein, and can use the first signal to identify the event, its duration, and/or extent. This can allow the event and/or parameters associated with the event to be identified when the event is not known or induced.

When a first set of measurements is used as the basis for identifying the event, the first signal and the second signal can be different. For example, the first signal and the second signal can represent different physical measurements. Any type of signal used in industrial processes can be used for the first signal and the second signal. In some aspects, the first set of measurements can comprise, for example, at least one of an acoustic sensor measurement, a temperature sensor measurement (e.g., distributed temperature sensor (DTS) measurements and/or point temperature sensor measurements), flow meter measurements, pressure sensor measurements (e.g., distributed or point pressure sensor measurements), a strain sensor measurements, position sensor measurements, current meter measurements, level sensor measurements, phase sensor measurements, composition sensor measurements, optical sensor measurements, image sensor measurements, or any combination thereof. While the temperature and/or acoustic monitoring techniques described herein are indicated as being distributed measurements, any of the distributed measurements can also be achieved using one or more point sources, which can be individual or connected along a path (e.g., length 120).

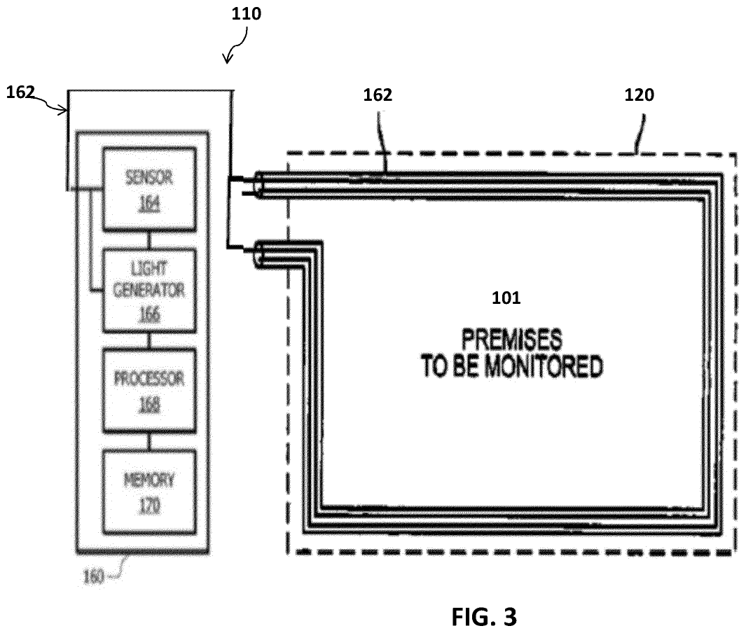

In aspects, the second set of measurements obtained at 15 comprises acoustic measurements obtained at the location (e.g., along a perimeter or periphery defined by a length of an optical fiber). Such acoustic measurements can be obtained as described hereinbelow with reference to FIG. 3, which is a schematic illustration of an environment or “premises” 101 according to some embodiments. As depicted in FIG. 3, fiber optic distributed acoustic sensors (DAS) can be utilized to capture distributed acoustic signals along a length 120 of an optical fiber 162, as described further hereinbelow.

As noted hereinabove, the first signal and the second signal represent different physical measurements. For example, in embodiments wherein the second set of measurements obtained at 15 comprise acoustic measurements obtained at the location, the first set of measurements will not comprise such acoustic measurements or measurements of acoustic waves. In embodiments, the first set of measurements can comprise, for example, at least one of temperature sensor measurements (e.g., distributed temperature sensor (DTS) measurements and/or point temperature sensor measurements), flow meter measurements, pressure sensor measurements (e.g., distributed or point pressure sensor measurements), a strain sensor measurements, position sensor measurements, current meter measurements, or any combination thereof.

In some aspects, fiber optic distributed temperature sensors (DTS) can be utilized to capture distributed temperature sensing signals, as described further hereinbelow. Although DTS is detailed hereinbelow, it is to be understood that a variety of combinations of first signal and second signal can be utilized to train one or more event models using the second set of measurements of the second signal and one or more events identified using the first set of measurements of the first signal of field data. That is, in embodiments, neither the first set of measurements nor the second set of measurements comprises DTS measurements; in embodiments, neither the first set of measurements nor the second set of measurements comprises DAS measurements; in embodiments, neither the first set of measurements nor the second set of measurements comprises DTS or DAS measurements.

In some instances, the systems and methods can provide information in real time or near real time. As used herein, the term “real time” refers to a time that takes into account various communication and latency delays within a system, and can include actions taken within about ten seconds, within about thirty seconds, within about a minute, within about five minutes, or within about ten minutes of the action occurring. Various sensors (e.g., distributed temperature sensing sensors, distributed fiber optic acoustic sensors, point temperature sensors, point acoustic sensors, flow meters, pressure sensors, etc.) can be used to obtain a distributed sensor measurements such as distributed temperature signal and/or an acoustic signal at various points or locations along a length 120 being monitored, for example, along a perimeter of the premises 101, along a transportation pathway, along a length connecting equipment, etc. Various processing can then be performed to obtain features and/or derived parameters from the sensor signals. For example, the distributed temperature sensing signal and/or the acoustic signal can then be processed using signal processing architecture with various feature extraction techniques (e.g., temperature feature extraction techniques, spectral feature extraction techniques) to obtain a measure of one or more temperature features, one or more frequency domain features, and/or combinations thereof that enable selectively extracting the distributed temperature sensing signals and acoustic signals of interest from background noise and consequently aiding in improving the accuracy of the identification of events, including, for example, the movement of fluids, people, vehicles, etc. in real time. While discussed in terms of being real time in some instances, the data can also be analyzed at a later time at the same location and/or a displaced location. For example, the data can be logged and later analyzed at the same or a different location.

As used herein, various frequency domain features can be obtained from the acoustic signal, and in some contexts, the frequency domain features can also be referred to herein as spectral features or spectral descriptors. In some embodiments, the spectral features can comprise other features, including those in the time domain, various transforms (e.g., wavelets, Fourier transforms, etc.), and/or those derived from portions of the acoustic signal or other sensor inputs. Such other features can be used on their own or in combination with one or more frequency domain features, including in the development of transformations of the features, as described in more detail herein.

In some embodiments, distributed temperature sensing signals and acoustic signal(s) can be obtained in a manner that allows for a signal to be obtained along a length of the sensor, for example, an entire length or a portion of interest (e.g., a length) thereof. In some contexts, a portion of the length of a distributed sensor can be referred to as a channel. The channel represents a specific section of the length such as a resolution length along the sensor (e.g., 10 meters of length, 5 meters of length, 1 meter of length, etc.)

Fiber optic distributed temperature sensors (DTS) and fiber optic distributed acoustic sensors (DAS) can capture distributed temperature sensing and acoustic signals, respectively, resulting from events, as well as other background events. This allows for signal processing procedures that distinguish events and signals from other sources to properly identify each type of event. This in turn results in a need for a clearer understanding of the fingerprint of an event of interest in order to be able to segregate and identify a signal resulting from an event of interest from other ambient background signals. As used herein, the resulting fingerprint of a particular event can also be referred to as an event signature, as described in more detail herein. In some embodiments, temperature features and acoustic features can each be used with a model (e.g., a machine learning model such as a multivariate model, neural network, etc.) to provide for detection, identification, and/or determination of the extents of various events. A number of different models can be developed and used to determine when and where certain events have occurred and/or the extents of such events.

The ability to identify various events may allow for various actions or processes to be taken in response to the events. For example, reducing damage resulting from one or more events such as equipment failure, pipeline leaks, or vehicle ingress and facilitating effective response strategies thereto relies upon accurate and timely decision support to inform the operator of the events. An effective response, when needed, benefits not just from a binary yes/no output of an identification/detection of events but also from a measure of an extent of the event, such as a degree of equipment failure, and amount of fluid leaking from a pipeline, or a number and type of vehicles crossing a perimeter from each of the identified locations of events so that locations contributing the greatest amount(s) can be acted upon first to improve or optimize a response. The systems and methods described herein can be used, in applications, to identify the source of an event or problem, as well as additional information about the event (referred to herein as an “extent” of the event), such as an identification of the type of problem being faced. For example, when an event comprising a security breach and a location thereof are detected, determination of an extent of the breach comprising a number of people, animals, or vehicles involved in the breach at the location may allow for a determination of whether or not to take action, and/or the type or method of response, the timing for response. For example, breached locations can be isolated, security personnel can be dispatched to the locations, alarms can be triggered, and the like. Such determinations can be used to improve the response.

Once obtained, the features from the signals comprising the sensor information such as temperature and acoustic features can be used in various models in order to be able to segregate a signal resulting from an event of interest from other ambient background noise. The features can comprise various information derived from any of the sensor signals, as described in more detail herein. Specific models can be determined for each event by considering one or more features for each event such as one or more temperature features and/or acoustic features for known events. The combination of the temperature features and/or acoustic features with an identification of the event and/or parameters associated with the event can be used to form a known data set used for training, which can be referred to as a labeled data set. From these known events, the temperature and/or acoustic features specific to each event can be developed and signatures (e.g., having ranges or thresholds) and/or models can be established to determine a presence (or absence) of each event. Based on the specifics of each feature, the resulting signatures or models can be used to sufficiently distinguish between events to allow for a relatively fast identification of such events. The resulting signatures or models can then be used along with processed signal data to determine if an event is occurring at a location of interest along the path (length 120) of the sensor(s).

Any of the processing techniques disclosed herein can be used to initially determine a signature or model(s), and then processed and compared the sensor features in a sampled temperature sensing and/or acoustic signal with the resulting signatures or model(s). According to this disclosure, the events can be identified based on being known or induced events, and/or identified using a first set of measurements of a first signal associated with a process with one or more first event models. The identification of the event can then be used with a second set of measurements to provide labeled data that can be used to determine and/or train one or more second event models using sensor data that is physically disparate from the first set of measurements. In some aspects the determination and/or training of the one or more second event models can comprise using one or more known second event models, and using the identified labeled data to calibrate the model, for example, by adjusting one or more parameters or aspects of the model to match the in-situ data.

The systems and methods of this disclosure can be utilized for detecting (e.g., identifying one or more events out of many potential events) and characterizing the identified events. In some aspects, the identification of the event(s) can be based on using the sensor measurements at each location associated with the sensor for a given sampling period, and multiple measurements through time and/or along a length of the sensor path may not be needed in order to identify one or more events from multiple possible events (e.g., the event identification need not be known prior to detecting the signals).

As described herein, temperature features and/or spectral descriptors or ‘frequency domain features’ can be used with DTS temperature and/or DAS acoustic data processing, respectively, to provide for event detection and/or event extent determination. One or more first or event models can be utilized herein for event identification. Once identified, the event identification along with a second set of measurements from a second sensor (e.g., labeled data) can subsequently be utilized to train one or more second event models. Once trained, the one or more second event models can be utilized alone or in combination with one or more first event models or other sensor data to predict at least one additional event (e.g., one or more additional occurrence of the event, etc.) using the second sensor data at one or more locations along the path or area being monitored. The at least one additional event can occur at the same location or another location. For example, the one or more second event models can be trained and used at other locations to identify the presence and identification of the events at those other locations.

In some aspects, the event identification and corresponding data obtained using the additional sensors can be used to calibrate existing models. In this context, training the one or more second event models can include a calibration process. In some aspects, the models or structure of the model (e.g., the type of model, identification of the model variables, etc.) can be known or pre-trained, and the event identification and corresponding data can be used as a new training data set or used to supplement the original training data set to re-train the one or more second event models. For example, a model can be developed using laboratory and/or testing data, and the event identification (e.g., using a known or induced event, using one or more first event models, etc.) can be used with the second set of measurements to re-train or calibrate the developed model alone or in combination with the laboratory or testing data. This process may allow the structure of the model (e.g., the features relied upon, the relationship of the features, etc.) to remain the same while updating various derived parameters of the model. For example, one or more parameters (e.g., coefficients, weightings, etc.) to be updated or calibrated to provide a more accurate model using data obtained from an actual in-situ generation of the sensor data. This process may be useful to calibrate existing models for specific applications or environments to improve the event identifications in those locations and account for variations between locations, wellbores, etc.

In some aspects, the calibration of the models can be used to identify calibrations for one or more additional event models. As noted above, the identified labeled data can be used to re-train and/or calibrate existing model(s), thereby updating one or more parameters of the existing model(s). When the parameters of the existing model(s) are redetermined or calibrated, a calibration factor can be developed that can be applied to other existing model(s). The calibration factor can then allow for one or more additional existing models to be updated to improve the accuracy of the models without needing data derived from an in-situ occurrence of the event.

For example, an in-situ event such as a bearing failure in rotating equipment can be determined based on having a known or induced event and/or using data associated with a bearing failure along with one or more event models. Once the event is identified, a second set of measurements can be obtained as described herein, and along with the event identification, the second set of measurements can be used to provide a labeled data set. In this example, acoustic data associated with a bearing failure can be obtained during the bearing failure event. The resulting labeled data set can be used to calibrate one or more second event models used for detecting a bearing failure using one or more frequency domain features derived from the acoustic data. An existing model may be developed based on test data such as simulating a bearing failure in a test apparatus. The structure of the existing model (e.g., the specific one or more frequency domain features used, and the relationship of the one or more frequency domain features to each other) can be used in the training process with the labeled data set. When the parameters of the existing model are re-determined, a calibration factor that correlates to the original parameters of the existing model, and updated parameters of the calibrated model can be determined. The calibration factor can then be applied to similar existing models such as a different pump bearing failure, a turbine bearing failure, and the like. The calibration factor can then help to adjust one or more existing models to more accurately reflect the parameters relevant to the location in which the in-situ data is obtained without the need for the specific event identified by the model to occur.

The in-situ identification of training data can also be used to cross-check and validate existing models. For example, the in-situ identified data can be used to train the one or more second event models. When an additional event is identified using the one or more event models, the event identification can be used to identify additional data using the first signals, which would correspond to the first set of measurements. The first event models can be trained to verify whether or not the newly trained model matches the original model(s) (e.g., the first event models) within a given threshold. When the models match, the system can provide an indication that the event is the only event present. When the models do not match, it can be an indication that another, unidentified event is present within the data. Additional training and event identification can then be used to identify the additional event. The cross-checking and validation process can be carried out using subsequent data in time, at different locations, and/or across different locations.

In some embodiments, use of the systems and methods described herein may provide knowledge of the events, including an identification of the event(s), and the locations experiencing various events, thereby potentially allowing for improved actions (e.g., security actions for security events, rerouting for transportation events, etc.) based on the processing results. The methods and systems disclosed herein can also provide information on the events. Embodiments of the systems and methods disclosed herein can also allow for a computation of the relative degree of an event, thereby offering the potential for a more targeted and effective response.

As disclosed herein, embodiments of the data processing techniques can use various sequences of real time digital signal processing steps to identify the sensor signals resulting from various events from background noise, and allow real time detection of the events and their locations using sensor data such as distributed fiber optic temperature and/or acoustic sensor data as the input data feed.

One or more models can be developed using available data along with parameters for the event(s) to provide a labeled data set used as input for training the model. Since the data can be identified along with the corresponding event during operation (e.g., during operation of a security system, transportation monitoring system, pipeline monitoring system, etc.), the data can be referred to as in-situ training data. The resulting trained models can then be used to identify one or more signatures based on features of the test data and one or more machine learning techniques to develop correlations for the presence of various events. The models can be determined in a number of ways. In some model developments, specific events can be created in a test set-up, and the sensor data signals can be obtained and recorded to develop test data. The test data can be used to train one or more models defining the various events. The resulting model can then be used to determine one or more events. In some embodiments, actual field data can be used and correlated to actual events using inputs from, for example, other temperature sensors, other acoustic sensors, and/or other production sensors (e.g., pressure sensors, flow meters, optical sensors, etc.) to provide in-situ data used for training the one or more models. The data can be labeled to create a training data set based on actual production situations (e.g., in-situ data). The data can then be used alone or in combination with the test data to develop the model(s). According to this disclosure, one or more event models are trained using a second set of measurements of a second signal and identification of one or more events provided with a first set of measurements of a first signal of field data at the location.

In some aspects the first set of measurement and/or the second set of measurements can comprise temperature and/or acoustic measurements. In these aspects, the sensor signals can comprise temperature and/or acoustic signals, and features can be obtained from the sensor signals. For example, temperature features and/or acoustic features can be determined from respective measurements taken along a length 120, for example, a length along a perimeter or periphery of premises 101. In some embodiments, the temperature and/or acoustic measurements can be used with one or more temperature and/or acoustic signatures, respectively, to determine the presence of absence of an event. The signatures can comprise a number of thresholds or ranges for comparison with various features. When the detected features fall within the signatures, the event may be determined to be present. In some embodiments, temperature measurements can be used in one or more first event detection models that can provide an output indicative of the presence or absence of one or more events along the length 120. This can allow event locations to be identified using temperature based measurements along length 120. When combined with a distributed temperature sensing system that can provide distributed and continuous temperature measurements, the systems can allow event locations to be tracked through time. The identified event locations can be utilized as described herein to identify data from a different physical parameter that can be used to train one or more second event models.

An exemplary system of this disclosure will now be described with reference to a FIG. 3, which is a schematic of an operating environment or “premises” 101 according to some embodiments. More specifically, environment 101 includes a perimeter or periphery traversed by optical fiber 162 along length 120. Although described as a periphery or perimeter, any length 120 along a premises 101 can be monitored, for example, a length of train track or road for transportation monitoring applications, a length around a building for security monitoring applications, a length of fiber optical cable disposed in contact with one or more pieces of equipment, etc. That is, the monitored length need not be a periphery in the usual sense, as it need not (but can, in some aspects) surround or encircle any specific area of the premises.

Referring still to FIG. 3, a monitoring system 110 can comprise an acoustic monitoring system and/or a temperature monitoring system. The monitoring system 110 can be positioned on or proximate the premises 101. As described herein, the monitoring system 110 may be utilized to detect or monitor event(s) on the premises 101. The various monitoring systems (e.g., acoustic monitoring systems, temperature monitoring systems, etc.) may be referred to herein as a “detection system,” and/or a “monitoring system.”

In some aspects, the monitoring system 110 can comprise an optical fiber 162 that extends along length 120 (e.g., the periphery) of premises 101. Referring again to FIG. 3, generally speaking, during operation of a the monitoring system, an optical backscatter component of light injected into the optical fiber 162 may be used to detect various conditions incident on the optical fiber such as acoustic perturbations (e.g., dynamic strain), temperature, static strain, and the like along the length of the optical fiber 162. The light can be generated by a light generator or source 166 such as a laser, which can generate light pulses. The light used in the system is not limited to the visible spectrum, and light of any frequency can be used with the systems described herein. Accordingly, the optical fiber 162 acts as the sensor element with no additional transducers in the optical path, and measurements can be taken along the length of the entire optical fiber 162. The measurements can then be detected by an optical receiver such as sensor 164 and selectively filtered to obtain measurements from a given location or range, thereby providing for a distributed measurement that has selective data for a plurality of locations or zones along the optical fiber 162 at any given time. For example, time of flight measurements of the backscattered light can be used to identify measurement lengths of the fiber optic 162. In this manner, the optical fiber 162 effectively functions as a distributed array of sensors spread over the entire length of the optical fiber 162.

The light backscattered up the optical fiber 162 as a result of the optical backscatter can travel back to the source 166, where the signal can be collected by a sensor 164 and processed (e.g., using a processor 168). In general, the time the light takes to return to the collection point is proportional to the distance traveled along the optical fiber 162, thereby allowing time of flight measurements of distance along the optical fiber 162. The resulting backscattered light arising along the length of the optical fiber 162 can be used to characterize the environment around the optical fiber 162. The use of a controlled light source 166 (e.g., having a controlled spectral width and frequency) may allow the backscatter to be collected and any parameters and/or disturbances along the length of the optical fiber 162 to be analyzed. In general, the various parameters and/or disturbances along the length of the optical fiber 162 can result in a change in the properties of the backscattered light.

An acquisition device 160 may be coupled to one end of the optical fiber 162 that comprises the sensor 164, light generator 166, a processor 168, and a memory 170. As discussed herein, the light source 166 can generate the light (e.g., one or more light pulses), and the sensor 164 can collect and analyze the backscattered light returning up the optical fiber 162. In some contexts, the acquisition device 160 (which comprises the light source 166 and the sensor 164 as noted above), can be referred to as an interrogator. The processor 168 may be in signal communication with the sensor 164 and may perform various analysis steps described in more detail herein. While shown as being within the acquisition device 160, the processor 168 can also be located outside of the acquisition device 160 including being located remotely from the acquisition device 160. The sensor 164 can be used to obtain data at various rates and may obtain data at a sufficient rate to detect the acoustic signals of interest with sufficient bandwidth. While described as a sensor 164 in a singular sense, the sensor 164 can comprise one or more photodetectors or other sensors that can allow one or more light beams and/or backscattered light to be detected for further processing. In an embodiment, distance resolution ranges (e.g. channel lengths) in a range of from about 1 meter to about 10 meters, or less than or equal to about 10, 9, 8, 7, 6, 5, 4, 3, 2, or 1 meter can be achieved. Depending on the resolution needed, larger averages or ranges can be used for computing purposes. When a high distance resolution is not needed, a system may have a wider resolution (e.g., which may be less expensive) can also be used in some embodiments. Data acquired by the monitoring system 110 (e.g., via fiber 162, sensor 164, etc.) may be stored on memory 170.

The monitoring system 110 can be used for detecting a variety of parameters and/or disturbances about the premises 101 being monitored, including being used to detect temperatures along the length 120, acoustic signals along the length 120, static strain and/or pressure along the length 120, flow rate along length 120, current along length 120, or any combination thereof.

In some embodiments, the monitoring system 110 can be used to detect temperatures along the length 120. The temperature monitoring system can include a distributed temperature sensing (DTS) system. A DTS system can rely on light injected into the optical fiber 162 along with the reflected signals to determine a temperature and/or strain based on optical time-domain reflectometry. In order to obtain DTS measurements, a pulsed laser from the light generator 166 can be coupled to the optical fiber 162 that serves as the sensing element. The injected light can be backscattered as the pulse propagates through the optical fiber 162 owing to density and composition as well as to molecular and bulk vibrations. A portion of the backscattered light can be guided back to the acquisition device 160 and split of by a directional coupler to a sensor 164. It is expected that the intensity of the backscattered light decays exponentially with time. As the speed of light within the optical fiber 162 is known, the distance that the light has passed through the optical fiber 162 can be derived using time of flight measurements.

In both distributed acoustic sensing (DAS) and DTS systems, the backscattered light includes different spectral components which contain peaks that are known as Rayleigh and Brillouin peaks and Raman bands. The Rayleigh peaks are independent of temperature and can be used to determine the DAS components of the backscattered light. The Raman spectral bands are caused by thermally influenced molecular vibrations. The Raman spectral bands can then be used to obtain information about distribution of temperature along the length of the optical fiber 162 disposed about the premises 101.

The Raman backscattered light has two components, Stokes and Anti-Stokes, one being only weakly dependent on temperature and the other being greatly influenced by temperature. The relative intensities between the Stokes and Anti-Stokes components are a function of temperature at which the backscattering occurred. Therefore, temperature can be determined at any point along the length of the optical fiber 162 by comparing at each point the Stokes and Anti-stokes components of the light backscattered from the particular point. The Brillouin peaks may be used to monitor strain along the length of the optical fiber 162.

The DTS system can then be used to provide a temperature measurement along the length 120. The DTS system can represent a separate system from the DAS system or a single common system, which can comprise one or more acquisition devices in some embodiments. In some embodiments, a plurality of fibers 162 are present at the premises 101, and the DAS system can be coupled to a first optical fiber and the DTS system can be coupled to a second, different, optical fiber. Alternatively, a single optical fiber can be used with both systems, and a time division multiplexing or other process can be used to measure both DAS and DTS on the same optical fiber.

In an embodiment, distance resolution (e.g., channel lengths) for the DTS system can range from about 1 meter to about 10 meters, or less than or equal to about 10, 9, 8, 7, 6, 5, 4, 3, 2, or 1 meter. Depending on the resolution needed, larger averages or ranges can be used for computing purposes. When a high distance resolution is not needed, a system having a wider resolution (e.g., which may be less expensive) can also be used in some embodiments. Data acquired by the DTS monitoring system 110 (e.g., via fiber 162, sensor 164, etc.) may be stored on memory 170.

While the temperature monitoring system described herein can use a DTS system to acquire the temperature measurements for a location or distance range about length 120, in general, any suitable temperature monitoring system can be used. For example, various point sensors, thermocouples, resistive temperature sensors, or other sensors can be used to provide temperature measurements at a given location based on the temperature measurement processing described herein. Further, an optical fiber comprising a plurality of point sensors such as Bragg gratings can also be used. As described herein, a benefit of the use of the DTS system is that temperature measurements can be obtained across a plurality of locations and/or across a continuous length about premises 101 rather than at discrete locations.

The monitoring system 110 can comprise an acoustic monitoring system to monitor acoustic signals about the premises 101. The acoustic monitoring system can comprise a DAS based system, though other types of acoustic monitoring systems, including other distributed monitoring systems, can also be used.

During operation of a DAS system an optical backscatter component of light injected into the optical fiber 162 (e.g., Rayleigh backscatter) may be used to detect acoustic perturbations (e.g., dynamic strain) along the length of the fiber 162. The light backscattered along the optical fiber 162 as a result of the optical backscatter can travel back to the source, where the signal can be collected by a sensor 164 and processed (e.g., using a processor 168) as described herein. In general, any acoustic or dynamic strain disturbances along the length of the optical fiber 162 can result in a change in the properties of the backscattered light, allowing for a distributed measurement of both the acoustic magnitude (e.g., amplitude), frequency and, in some cases, of the relative phase of the disturbance. Any suitable detection methods including the use of highly coherent light beams, compensating interferometers, local oscillators, and the like can be used to produce one or more signals that can be processed to determine the acoustic signals or strain impacting the optical fiber along its length.

While the system described herein can be used with a DAS system (e.g., DAS system 110) to acquire an acoustic signal for a location or distance range along length 120, in general, any suitable acoustic signal acquisition system can be used in performing embodiments of method 10 (see e.g., FIG. 1A). For example, various microphones, geophones, hydrophones, or other sensors can be used to provide an acoustic signal at a given location based on the acoustic signal processing described herein. Further, an optical fiber comprising a plurality of point sensors such as Bragg gratings can also be used. As described herein, a benefit of the use of the DAS system 110 is that an acoustic signal can be obtained across a plurality of locations and/or across a continuous length 120 about premises 101 rather than at discrete locations.

The monitoring system 110 can be used to generate temperature measurements and/or acoustic measurements along the length 120. The resulting measurements can be processed to obtain various temperature and/or acoustic based features that can then be used to identify event locations, and/or quantify the extent of an event. Each of the specific types of features obtained from the monitoring system is described in more detail below.

During an event, acoustic signals and temperature changes can be created that can be detected by the monitoring system such as the DTS system and/or the DAS systems as described herein. With respect to the temperature variations, the temperature changes can result from various events. For example, when the length 120 comprises a train track, passage of a train can cause a change in temperature. When length 120 comprises a periphery of a building, passage of people, vehicles, or animals about the length 120 can cause a temperature increase. Within buildings, the opening and closing of doors can also result in a change in temperature relative to the ambient temperatures. The magnitude of the temperature change can depends on the type and extent of the event. Other types of sensors such as optical sensors (e.g., still or video cameras, thermal cameras, etc.) can also be used to detect various sensor signals and changes in the environment that can be used with the system.

As an example, by obtaining the temperature along the length 120, a number of temperature features can be obtained from the temperature measurements. The temperature features can provide an indication of one or more temperature trends at a given location along the length 120 during a measurement period. The resulting features can form a distribution of temperature results that can then be used with various models to identify one or more events on the premises 101 at the location.

The temperature measurements can represent output values from the DTS system, which can be used with or without various types of pre-processing such as noise reduction, smoothing, and the like. When background temperature measurements are used, the background measurement can represent a temperature measurement at a location on the premises 101 taken in the absence of the event. For example, a temperature profile along the length 120 can be taken when the event is not occurring, by measuring the temperatures at various points along the length 120. The resulting background temperature measurements or temperature profile can then be used in determining the temperature features in some embodiments.

In general, the temperature features represent statistical variations of the temperature measurements through time and/or distance. For example, the temperature features can represent statistical measurements or functions of the temperature along the length 120 that can be used with various models to determine whether or not various events have occurred. The temperature features can be determined using various functions and transformations, and in some embodiments can represent a distribution of results. In some embodiments, the temperature features can represent a normal or Gaussian distribution. In some embodiments, the temperature measurements can represent measurement through time and distance, such as variations taken first with respect to time and then with respect to distance or first with respect to distance and then with respect to time. The resulting distributions can then be used with models such as multivariate models to determine the presence of the events.

In some embodiments, the temperature features can include various features including, but not limited to, a distance derivative of temperature with respect to distance (e.g., length 120), a temperature excursion measurement, a baseline temperature excursion, a peak-to-peak value, a Fast Fourier transform (FFT), a Laplace transform, a wavelet transform, a derivative of temperature with respect to distance, a heat loss parameter, an autocorrelation, and combinations thereof.

In some embodiments, the temperature features can comprise a distance derivative of temperature with respect to distance. This feature can be determined by taking the temperature measurements along the length 120 and smoothing the measurements. Smoothing can comprise a variety of steps including filtering the results, de-noising the results, or the like. In some embodiments, the temperature measurements can be median filtered within a given window to smooth the measurements. Once smoothed, the change in the temperature with distance can be determined. The distance derivative of temperature values can then be processed, and the measurement with a zero value (e.g., representing a point of no change in temperature with distance) that have preceding and proceeding values that are non-zero and have opposite signs in distance (e.g., zero below which the value is negative and above positive or vice versa) can have the values assign to the nearest value. This can then result in a set of measurements representing the distance derivative of temperature with respect to distance. In applications, such as geothermal event monitoring for example, the distance can be a depth from a surface of the premises 101.

In some embodiments, the temperature features can comprise a temperature excursion measurement. The temperature excursion measurement can comprise a difference between a temperature reading at a first distance or location and a smoothed temperature reading over a distance range, where the first distance is within the distance range. In some embodiments, the temperature excursion measurement can represent a difference between de-trended temperature measurements over an interval and the actual temperature measurements within the interval. For example, a distance range can be selected along length 120. The temperature readings within a time window can be obtained within the distance range and de-trended or smoothed. In some embodiments, the de-trending or smoothing can include any of those processes described above, such as using median filtering of the data within a window within the distance range. For median filtering, the larger the window of values used, the greater the smoothing effect can be on the measurements. For the temperature excursion measurement, a range of windows from about 10 to about 100 values, or between about 20-60 values (e.g., measurements of temperature within the distance range) can be used to median filter the temperature measurements. A difference can then be taken between the temperature measurement at a location and the de-trended (e.g., median filtered) temperature values. The temperature measurements at a location can be within the distance range and the values being used for the median filtering. This temperature feature then represents a temperature excursion at a location along the length 120 from a smoothed temperature measurement over a larger range of distances around the location along the length 120.

In some embodiments, the temperature features can comprise a baseline temperature excursion. The baseline temperature excursion represents a difference between a de-trended baseline temperature profile and the current temperature at a given distance. In some embodiments, the baseline temperature excursion can rely on a baseline temperature profile that can contain or define the baseline temperatures along the length 120. As described herein, the baseline temperatures represent the temperature as measured when the event is not occurring. If the condition of the premises 101 changes over time, a new baseline temperature profile can be measured or determined. It is not expected that the baseline temperature profile is re-determined at specific intervals, and rather it would be determined at discrete times. In some embodiments, the baseline temperature profile can be re-determined and used to determine one or more temperature features such as the baseline temperature excursion.

Once the baseline temperature profile is obtained, the baseline temperature measurements at a location along the length 120 can be subtracted from the temperature measurement detected by the temperature monitoring system 110 at that location to provide baseline subtracted values. The results can then be obtained and smoothed or de-trended. For example, the resulting baseline subtracted values can be median filtered within a window to smooth the data. In some embodiments, a window between 10 and 500 temperature values, between 50 and 400 temperature values, or between 100 and 300 temperature values can be used to median filter the resulting baseline subtracted values. The resulting smoothed baseline subtracted values can then be processed to determine a change in the smoothed baseline subtracted values with distance. In some embodiments, this can include taking a derivative of the smoothed baseline subtracted values with respect to distance along the length 120. The resulting values can represent the baseline temperature excursion feature.

In some embodiments, the temperature features can comprise a peak-to-peak temperature value. This feature can represent the difference between the maximum and minimum values (e.g., the range, etc.) within the temperature profile along the length 120. In some embodiments, the peak-to-peak temperature values can be determined by detecting the maximum temperature readings (e.g., the peaks) and the minimum temperature values (e.g., the dips) within the temperature profile along the length 120. The difference can then be determined within the temperature profile to determine peak-to-peak values along the length 120. The resulting peak-to-peak values can then be processed to determine a change in the peak-to-peak values with respect to distance. In some embodiments, this can include taking a derivative of the peak-to-peak values with respect to distance along the length 120. The resulting values can represent the peak-to-peak temperature values.

Other temperature features can also be determined from the temperature measurements. In some embodiments, various statistical measurements can be obtained from the temperature measurements along the length 120 to determine one or more temperature features. For example, a cross-correlation of the temperature measurements with respect to time can be used to determine a cross-correlated temperature feature. The temperature measurements can be smoothed as described herein prior to determining the cross-correlation with respect to time. As another example, an autocorrelation measurement of the temperature measurements can be obtained with respect to distance. Autocorrelation is defined as the cross-correlation of a signal with itself. An autocorrelation temperature feature can thus measure the similarity of the signal with itself as a function of the displacement. An autocorrelation temperature feature can be used, in applications, as a means of anomaly detection for event (e.g., fluid inflow) detection. The temperature measurements can be smoothed and/or the resulting autocorrelation measurements can be smoothed as described herein to determine the autocorrelation temperature features.

In some embodiments, the temperature features can comprise a Fast Fourier transform (FFT) of the distributed temperature sensing (e.g., DTS) signal. This algorithm can transform the distributed temperature sensing signal from the time domain into the frequency domain, thus allowing detection of the deviation in DTS along length 120 (e.g., distance or depth). This temperature feature can be utilized, for example, for anomaly detection for event detection purposes.

In some embodiments, the temperature features can comprise the Laplace transform of DTS. This algorithm can transform the DTS signal from the time domain into Laplace domain allowing detection of the deviation in the DTS along length 120. This temperature feature can be utilized, for example, for anomaly detection for event detection. This feature can be utilized, for example, in addition to (e.g., in combination with) the FFT temperature feature.

In some embodiments, the temperature features can comprise a wavelet transform of the distributed temperature sensing (e.g., DTS) signal and/or of the derivative of DTS with respect to distance, dT/dz. The wavelet transform can be used to represent the abrupt changes in the signal data. This feature can be utilized, for example, in fluid inflow detection. A wavelet is described as an oscillation that has zero mean, which can thus make the derivative of DTS in depth more suitable for this application. In embodiments and without limitation, the wavelet can comprise a Morse wavelet, an Analytical wavelet, a Bump wavelet, or a combination thereof.

In some embodiments, the temperature features can comprise a derivative of DTS with respect to length 120, or dT/dz.

In some embodiments, the temperature features can comprise a heat loss parameter. In some embodiments, the temperature features can comprise a time-depth derivative and/or a depth-time derivative. A temperature feature comprising a time-depth derivative can comprise a change in a temperature measurement at one or more locations along the length 120 taken first with respect to time, and a change in the resulting values with respect to length can then be determined. Similarly, a temperature feature comprising a depth-time derivative can comprise a change in a temperature measurement at one or more locations along the length 120 taken first with respect to distance, and a change in the resulting values with respect to time can then be determined.

In some embodiments, the temperature features can be based on dynamic temperature measurements rather than steady state temperature measurements. In order to obtain dynamic temperature measurements, a change in the operation of the system can be introduced, and the temperature monitored using the temperature monitoring system. For example, the change in conditions can be introduced by introducing a fluid, or the like. One or more temperature features can be determined using the dynamic temperature measurements. Once the temperature features are determined from the temperature measurements obtained from the temperature monitoring system, one or more of the temperature features can be used to identify events along the length 120 being monitored, as described in more detail herein.

As described with respect to the temperature measurements, the event can also create acoustic sounds that can be detected using the acoustic monitoring system such as a DAS system. For example, the flow of various fluids and/or the passage of beings or vehicles about the premises 101 can create vibrations or acoustic sounds that can be detected using an acoustic monitoring system. Each type of event can produce an acoustic signature with unique frequency domain features.

As used herein, various frequency domain features can be obtained from the acoustic signal, and in some contexts, the frequency domain features can also be referred to herein as spectral features or spectral descriptors. The frequency domain features are features obtained from a frequency domain analysis of the acoustic signals obtained along the length 120. The frequency domain features can be derived from the full spectrum of the frequency domain of the acoustic signal such that each of the frequency domain features can be representative of the frequency spectrum of the acoustic signal. Further, a plurality of different frequency domain features can be obtained from the same acoustic signal (e.g., the same acoustic signal at a location along length 120), where each of the different frequency domain features is representative of frequencies across the same frequency spectrum of the acoustic signal as the other frequency domain features. For example, the frequency domain features (e.g., each frequency domain feature) can be a statistical shape measurement or spectral shape function of the spectral power measurement across the same frequency bandwidth of the acoustic signal. Further, as used herein, frequency domain features can also refer to features or feature sets derived from one or more frequency domain features, including combinations of features, mathematical modifications to the one or more frequency domain features, rates of change of the one or more frequency domain features, and the like.

The frequency domain features can be determined by processing the acoustic signals from premises 101 at one or more locations along the length 120. As the acoustics signals at a given location along the length 120 contain a combination of acoustic signals, the determination of the frequency domain features can be used to separate and identify individual events. As an example, passage of a train over train tracks to which optical fiber 162 is adjacent or attached can produce random, broadband acoustic signal that can be captured on the optical fiber 162 coupled (e.g., strapped) to the train tracks. The random excitation response can have a broadband acoustic signal

In addition to the train passing along length 120 of train tracks of premises 101, background noise can also be present. Other acoustic signal sources can include, for example, animals or people crossing the tracks. The combined acoustic signal can then be detected by the acoustic monitoring system. In order to detect one or more of these events, the acoustic signal can be processed to determine one or more frequency domain features of the acoustic signal at a location along length 120.

In order to determine the frequency domain features, an acoustic signal can be obtained using the acoustic monitoring system. The resulting acoustic signal can be optionally pre-processed using a number of steps. Depending on the type of DAS system employed, the optical data may or may not be phase coherent and may be pre-processed to improve the signal quality (e.g., denoised for opto-electronic noise normalization/de-trending single point-reflection noise removal through the use of median filtering techniques or even through the use of spatial moving average computations with averaging windows set to the spatial resolution of the acquisition unit, etc.). The raw optical data from the acoustic sensor can be received, processed, and generated by the sensor to produce the acoustic signal.

In some embodiments, a processor or collection of processors (e.g., processor 168 in FIG. 3) may be utilized to perform the optional pre-processing steps described herein. In an embodiment, the noise detrended “acoustic variant” data can be subjected to an optional spatial filtering step following the other pre-processing steps, if present. A spatial sample point filter can be applied that uses a filter to obtain a portion of the acoustic signal corresponding to a desired distance or distance range along the length 120. Since the time the light pulse sent into the optical fiber 162 returns as backscattered light can correspond to the travel distance, and therefore location along length 120, the acoustic data can be processed to obtain a sample indicative of the desired location or location range. This may allow a specific location along the length 120 to be isolated for further analysis. The pre-processing may also include removal of spurious back reflection type noises at specific locations through spatial median filtering or spatial averaging techniques. This is an optional step and helps focus primarily on an interval of interest along the length 120. For example, the spatial filtering step can be used to focus on a location where there is high likelihood of an event. The resulting data set produced through the conversion of the raw optical data can be referred to as the acoustic sample data.

The acoustic data, including the optionally pre-processed and/or filtered data, can be transformed from the time domain into the frequency domain using a transform. For example, a Fourier transform such as a Discrete Fourier transformations (DFT), a short time Fourier transform (STFT), or the like can be used to transform the acoustic data measured at each location along the fiber 162 or a section thereof into a frequency domain representation of the signal. The resulting frequency domain representation of the data can then be used to provide the data from which the plurality of frequency domain features can be determined. Spectral feature extraction using the frequency domain features through time and space can be used to determine one or more frequency domain features.

The use of frequency domain features to identify events and locations can provide a number of advantages. First, the use of frequency domain features results in significant data reduction relative to the raw DAS data stream. Thus, a number of frequency domain features can be calculated and used to allow for event identification while the remaining data can be discarded or otherwise stored, and the remaining analysis can performed using the frequency domain features. Even when the raw DAS data is stored, the remaining processing power is significantly reduced through the use of the frequency domain features rather than the raw acoustic data itself. Further, the use of the frequency domain features can, with the appropriate selection of one or more of the frequency domain features, provide a concise, quantitative measure of the spectral character or acoustic signature of specific sounds pertinent to events of interest (e.g., perimeter surveillance, transportation monitoring, and other applications).

While a number of frequency domain features can be determined for the acoustic sample data, not every frequency domain feature may be used to identify every event. The frequency domain features represent specific properties or characteristics of the acoustic signals.

In some embodiments, combinations of frequency domain features can be used as the frequency domain features themselves, and the resulting combinations are considered to be part of the frequency domain features as described herein. In some embodiments, a plurality of frequency domain features can be transformed to create values that can be used to define various event signatures. This can include mathematical transformations including ratios, equations, rates of change, transforms (e.g., wavelets, Fourier transforms, other wave form transforms, etc.), other features derived from the feature set, and/or the like as well as the use of various equations that can define lines, surfaces, volumes, or multi-variable envelopes. The transformation can use other measurements or values outside of the frequency domain features as part of the transformation. For example, time domain features, other acoustic features, and non-acoustic measurements can also be used. In this type of analysis, time can also be considered as a factor in addition to the frequency domain features themselves. As an example, a plurality of frequency domain features can be used to define a surface (e.g., a plane, a three-dimensional surface, etc.) in a multivariable space, and the measured frequency domain features can then be used to determine if the specific readings from an acoustic sample fall above or below the surface. The positioning of the readings relative to the surface can then be used to determine if the event is present or not at that location in that detected acoustic sample.

The frequency domain features can include any frequency domain features derived from the frequency domain representations of the acoustic data. Such frequency domain features can include, but are not limited to, the spectral centroid, the spectral spread, the spectral roll-off, the spectral skewness, the root mean square (RMS) band energy (or the normalized sub-band energies/band energy ratios), a loudness or total RMS energy, a spectral flatness, a spectral slope, a spectral kurtosis, a spectral flux, a spectral autocorrelation function, or a normalized variant thereof.

The spectral centroid denotes the “brightness” of the sound captured by the optical fiber (e.g., optical fiber 162 shown in FIG. 3) and indicates the center of gravity of the frequency spectrum in the acoustic sample. The spectral centroid can be calculated as the weighted mean of the frequencies present in the signal, where the magnitudes of the frequencies present can be used as their weights in some embodiments.

The spectral spread is a measure of the shape of the spectrum and helps measure how the spectrum is distributed around the spectral centroid. In order to compute the spectral spread, Si, one has to take the deviation of the spectrum from the computed centroid as per the following equation (all other terms defined above):

$${S}_{i} = \sqrt{\frac{{Σ}_{k = 1}^{N} {( f ( k ) - {C}_{i} )}^{2} {X}_{i} ( k )}{{Σ}_{k = 1}^{N} {X}_{i} ( k )}} . \qquad ( Eq . 2 )$$

The spectral roll-off is a measure of the bandwidth of the audio signal. The Spectral roll-off of the i^{th} frame, is defined as the frequency bin ‘y’ below which the accumulated magnitudes of the short-time Fourier transform reach a certain percentage value (usually between 85%-95%) of the overall sum of magnitudes of the spectrum.

$${\sum }_{k = 1}^{y} \vert {X}_{i} ( k ) \vert = \frac{c}{100} {\sum }_{k = 1}^{N} \vert {X}_{i} ( k ) \vert , \qquad ( Eq . 3 )$$

where c=85 or 95. The result of the spectral roll-off calculation is a bin index and enables distinguishing acoustic events based on dominant energy contributions in the frequency domain.

The spectral skewness measures the symmetry of the distribution of the spectral magnitude values around their arithmetic mean.

The RMS band energy provides a measure of the signal energy within defined frequency bins that may then be used for signal amplitude population. The selection of the bandwidths can be based on the characteristics of the captured acoustic signal. In some embodiments, a sub-band energy ratio representing the ratio of the upper frequency in the selected band to the lower frequency in the selected band can range between about 1.5:1 to about 3:1. In some embodiments, the sub-band energy ratio can range from about 2.5:1 to about 1.8:1, or alternatively be about 2:1. The total RMS energy of the acoustic waveform calculated in the time domain can indicate the loudness of the acoustic signal. In some embodiments, the total RMS energy can also be extracted from the temporal domain after filtering the signal for noise.

The spectral flatness is a measure of the noisiness/tonality of an acoustic spectrum. It can be computed by the ratio of the geometric mean to the arithmetic mean of the energy spectrum value and may be used as an alternative approach to detect broad-banded signals. For tonal signals, the spectral flatness can be close to 0 and for broader band signals it can be closer to 1.

The spectral slope provides a basic approximation of the spectrum shape by a linearly regressed line. The spectral slope represents the decrease of the spectral amplitudes from low to high frequencies (e.g., a spectral tilt). The slope, the y-intersection, and the max and media regression error may be used as features.

The spectral kurtosis provides a measure of the flatness of a distribution around the mean value.

The spectral flux is a measure of instantaneous changes in the magnitude of a spectrum. It provides a measure of the frame-to-frame squared difference of the spectral magnitude vector summed across all frequencies or a selected portion of the spectrum. Signals with slowly varying (or nearly constant) spectral properties (e.g., noise) have a low spectral flux, while signals with abrupt spectral changes have a high spectral flux. The spectral flux can allow for a direct measure of the local spectral rate of change and consequently serves as an event detection scheme that could be used to pick up the onset of acoustic events that may then be further analyzed using the feature set above to identify and uniquely classify the acoustic signal.

The spectral autocorrelation function provides a method in which the signal is shifted, and for each signal shift (lag) the correlation or the resemblance of the shifted signal with the original one is computed. This enables computation of the fundamental period by choosing the lag, for which the signal best resembles itself, for example, where the autocorrelation is maximized. Any of these frequency domain features, or any combination of these frequency domain features (including transformations of any of the frequency domain features and combinations thereof), can be used to detect and identify one or more events and locations on the premises 101. In an embodiment, a selected set of characteristics can be used to identify each event, and/or all of the frequency domain features that are calculated can be used as a group in characterizing the identity and location of the one or more events. The specific values for the frequency domain features that are calculated can vary depending on the specific attributes of the acoustic signal acquisition system, such that the absolute value of each frequency domain feature can change between systems. In some aspects, the frequency domain features can be calculated for each event based on the system being used to capture the acoustic signal and/or the differences between systems can be taken into account in determining the frequency domain feature values for each event between or among the systems used to determine the values and the systems used to capture the acoustic signal being evaluated. For example, the frequency domain features can be normalized based on the acquired values to provide more consistent readings between systems and locations.

One or a plurality of frequency domain features can be used to identify events and locations. In an embodiment, one, or at least two, three, four, five, six, seven, eight, etc. different frequency domain features can be used to detect events and locations. The frequency domain features can be combined or transformed in order to define the event signatures for one or more events. While exemplary numerical ranges are provided herein, the actual numerical results may vary depending on the data acquisition system and/or the values can be normalized or otherwise processed to provide different results.

In embodiments, the method 10 of identifying one or more events further comprises creating labeled data using the identified one or more events identified at 13 and the second set of measurements obtained at 15.

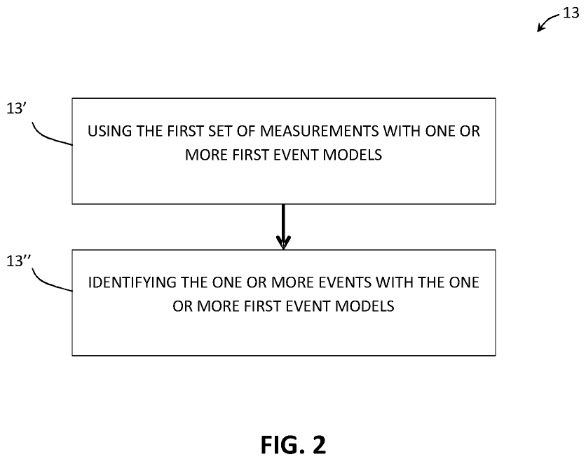

As depicted in FIG. 2, which is a flow diagram of identifying one or more events at the location using the first set of measurements at 13, in embodiments, identifying the one or more events at 13 comprises: using the first set of measurements with one or more first event models at 13′; and identifying the one or more events with the one or more first event models at 13″. For example, when the first set of measurements comprises DTS measurements, the first set of (e.g., DTS) measurements can be utilized as described hereinabove with one or more first event models to identify the one or more events.

In embodiments, subsequent training of the one or more event models at 17, the method 10 can further comprise at 19 (i.e., using the one or more event models to identify the at least one additional event at one or more locations): monitoring the first signal at the location; monitoring the second signal at the location; using the first signal in the one or more first event models; using the second signal in the (now trained) one or more event models; and detecting the at least one additional event based on outputs of both the one or more first event models and the one or more trained event models. In this manner, the trained one or more event models and the one or more first event models utilized to identify the one or more events at 13 at the location that were subsequently utilized to train the one or more event models at 17 can be utilized at 19 to identify the at least one additional event at one or more locations (that may or may not include the identified location utilized at 13).

In specific embodiments, the second signal can comprise an acoustic signal. A flow diagram of such an embodiment is provided in FIG. 1B. In such embodiments, a method of identifying events according to this disclosure can comprise: obtaining a first set of measurements comprising a first signal of field data at the location at 11; identifying one or more events at the location using the first set of measurements at 13; obtaining an acoustic data set at the location at 15, wherein the first signal is not an acoustic signal; training, at 17, one or more event models using the acoustic data set and the identification of the one or more events as inputs; and using the trained one or more event models at 19 to identify at least one additional event at the location or a second location.

In specific embodiments, the first signal is obtained across a plurality of locations. A flow diagram of such an embodiment is provided in FIG. 1C. In such embodiments, a method of identifying events according to this disclosure can comprise: obtaining a first set of measurements comprising a first signal of field data across a plurality of locations at 11; identifying one or more events at one or more locations of the plurality of locations using the first set of measurements at 13; obtaining a second set of measurements comprising a second signal across the plurality of locations at 15, wherein the first signal and the second signal represent at least one different physical measurements; training one or more event models at 17 using the second set of measurements at the one or more locations of the plurality of locations and the identification of the one or more events as inputs; and using the one or more event models at 19 to identify at least one additional event across the plurality of locations.

In such embodiments, training the one or more event models at 17 can comprise: training one or more first event models of the one or more event models using the second set of measurements at a first location of the one or more locations and the identification of the one or more events at the first location as inputs; training one or more second event models of the one of the one or more event models using the second set of measurements at a second location of the one or more locations and the identification of the one or more events at the second location as inputs; comparing the one or more first event models and the one or more second event models; and determining the one or more event models based on the comparison of the one or more first event models and the one or more second event models. In embodiments, training the one or more event models at 17 comprises: training the one or more event models using the second set of measurements from a plurality of locations of the one or more locations and the identification of the one or more events at the plurality of locations as inputs. in embodiments, training the one or more event models at 17 comprises: training one or more first event models of the one or more event models using the second set of measurements at a first location of the one or more locations at a first time and the identification of the one or more events at the first location as inputs; retraining the one or more first event models of the one or more event models using the second set of measurements at the first location of the one or more locations at a second time and the identification of the one or more events at the first location as inputs; comparing the trained one or more first event models and the retrained one or more first event models; and determining the one or more event models based on the comparison of the trained one or more first event models and the retrained one or more first event models.

As noted hereinabove, in embodiments wherein the second signal comprises an acoustic signal, the first set of measurements can comprise temperature (e.g., distributed temperature sensor (DTS)) measurements. Alternatively or additionally, the first set of measurements can comprise pressure sensor measurements, flow meter measurements, strain sensor measurements, position sensor measurements, current sensor measurements, or a combination thereof. Identifying the one or more events at the location at 13 can comprise: identifying a first event at the location using one or more first event models. Training the one or more event models at 17 can comprise: obtaining acoustic data for the location from the acoustic data set; and training the one or more event models using the acoustic data for the location and the identification of the first event at the location. Using the trained one or more event models to identify the at least one additional event at 19 can comprise using the one or more trained event models to identify the at least one additional event at a second location.

Referring to FIG. 1A, training the one or more event models at 17 can comprise: obtaining acoustic data for the first location from the acoustic data set (e.g., as described hereinabove with reference to FIG. 3); and training the one or more event models using the acoustic data for the first location and the identification of the first event at the first location. Using the trained one or more event models at 19 to identify the at least one additional event at the one or more locations can comprise using the one or more trained event models (optionally in conjunction with the one or more first event models) to identify the at least one additional event at one or more locations along length 120 of optical fiber 162.

Training the one or more event models at 17 can further comprise calibrating the one or more event models using the second set of measurements and the identification of the one or more events as inputs.

The method can further comprise: obtaining a third set of measurements comprising a third signal, wherein each of the first signal, the second signal, and the third signal represent at least one different physical measurement; training one or more third event models using the third set of measurements and at least one of: 1) the identification of the one or more events, or 2) the identification of the at least one additional event, as inputs; and using the one or more third event models to identify at least one third event at the one or more locations. The additional event can be identified along the length of the optical fiber 162, or in some aspects, another optical fiber.

Temperature features can be utilized to identify event locations. As noted hereinabove, temperature features can be utilized with one or more first event models to provide an output of the one or more first event models and then be utilized with the one or more event models to provide an output of the event model. Subsequent to training of the one or more event models, the presence (and/or extent) of the at least one additional event at one or more locations can be determined using an output from the one or more first event models, an output from the one or more trained event models, or a combined output obtained using the output from the one or more first event models and the output from the one or more event models.

The temperature features can be determined using the temperature monitoring system to obtain temperature measurements along the length 120 being monitored (e.g., the length about a perimeter of premises 101). In some embodiments, a DTS system can be used to receive distributed temperature measurement signals from a sensor disposed along the length 120, such as an optical fiber 162. The resulting signals from the temperature monitoring system can be used to determine one or more temperature features as described herein. In some embodiments, a baseline or background temperature profile can be used to determine the temperature features, and the baseline temperature profile can be obtained prior to obtaining the temperature measurements.

In some embodiments, a plurality of temperature features can be determined from the temperature measurements, and the plurality of temperature features can comprise at least two of: a depth derivative of temperature with respect to distance, a temperature excursion measurement, a baseline temperature excursion, a peak-to-peak value, a fast Fourier transform, a Laplace transform, a wavelet transform, a derivative of temperature with respect to length (e.g., distance, depth), a heat loss parameter, an autocorrelation, as detailed hereinabove, and/or the like. Other temperature features can also be used in some embodiments. The temperature excursion measurement can comprise a difference between a temperature reading at a first distance, and a smoothed temperature reading over a distance range, where the first distance is within the distance range. The baseline temperature excursion can comprise a derivative of a baseline excursion with distance, where the baseline excursion can comprise a difference between a baseline temperature profile and a smoothed temperature profile. The peak-to-peak value can comprise a derivative of a peak-to-peak difference with distance, where the peak-to-peak difference comprises a difference between a peak high temperature reading and a peak low temperature reading with an interval. The fast Fourier Transform can comprise an FFT of the distributed temperature sensing signal. The Laplace transform can comprise a Laplace transform of the distributed temperature sensing signal. The wavelet transform can comprise a wavelet transform of the distributed temperature sensing signal or of the derivative of the distributed temperature sensing signal with respect to length (e.g., depth). The derivative of the distributed temperature sensing signal with respect to length (e.g., depth) can comprise the derivative of the flowing temperature with respect to distance. The heat loss parameter can comprise one or more of the geothermal temperature, a deviation, dimensions of premises (e.g., train tracks) being monitored, or the like. The autocorrelation can comprise a cross-correlation of the distributed temperature sensing signal with itself.

Once the temperature features are obtained, the temperature features can be used with one or more first event models to identify the presence of the event at one or more locations. In some embodiments, the one or more first event models can accept a plurality of temperature features as inputs. In general, the temperature features are representative of feature at a particular location (e.g., a distance resolution portion of the optical fiber 162 along the length 120 being monitored) along the length 120. The one or more first event models can comprise one or more models configured to accept the temperature features as input(s) and provide an indication of whether or not there is an event at the particular location along the length 120. The output of the one or more first event models can be in the form of a binary yes/no result, and/or a likelihood of an event (e.g., a percentage likelihood, etc.). Other outputs providing an indication of an event are also possible. In some embodiments, the one or more first event models can comprise a multivariate model, a machine learning model using supervised or unsupervised learning algorithms, or the like. In some aspects, the event may be known or induced, and the use of the first event models may not be used to identify the event.

In some embodiments, the one or more first event models can comprise a multivariate model. A multivariate model allows for the use of a plurality of variables in a model to determine or predict an outcome. A multivariate model can be developed using known data on events along with temperature features for those events to develop a relationship between the temperature features and the presence of the event at the locations within the available data. One or more multivariate models can be developed using data, where each multivariate model uses a plurality of temperature features as inputs to determine the likelihood of an event occurring at the particular location along the length 120.

As noted above, in some embodiments, the one or more first event models can comprise one or more multivariate models. The multivariate model can use multivariate equations, and the multivariate model equations can use the temperature features or combinations or transformations thereof to determine when an event is present. The multivariate model can define a threshold, decision point, and/or decision boundary having any type of shapes such as a point, line, surface, or envelope between the presence and absence of the specific event. In some embodiments, the multivariate model can be in the form of a polynomial, though other representations are also possible. The model can include coefficients that can be calibrated based on known event data. While there can be variability or uncertainty in the resulting values used in the model, the uncertainty can be taken into account in the output of the model. Once calibrated or tuned, the model can then be used with the corresponding temperature features to provide an output that is indicative of the occurrence of an event.

The multivariate model is not limited to two dimensions (e.g., two temperature features or two variables representing transformed values from two or more temperature features), and rather can have any number of variables or dimensions in defining the threshold between the presence or absence of the event. When used, the detected values can be used in the multivariate model, and the calculated value can be compared to the model values. The presence of the event can be indicated when the calculated value is on one side of the threshold and the absence of the event can be indicated when the calculated value is on the other side of the threshold. In some embodiments, the output of the multivariate model can be based on a value from the model relative to a normal distribution for the model. Thus, the model can represent a distribution or envelope and the resulting temperature features can be used to define where the output of the model lies along the distribution at the location along the length 120 being monitored. Thus, each multivariate model can, in some embodiments, represent a specific determination between the presence of absence of an event at a specific location along the length 120. Different multivariate models, and therefore thresholds, can be used for different events, and each multivariate model can rely on different temperature features or combinations or transformations of temperature features. Since the multivariate models define thresholds for the determination and/or identification of events, the multivariate models and the one or more first event models using such multivariate models can be considered to be temperature based event signatures for each type of event.

In some embodiments, the one or more first event models can comprise a plurality of models. Each of the models can use one or more of the temperature features as inputs. The models can comprise any suitable model that can relate one or more temperature features to an occurrence of an event (e.g., a likelihood of the event, a binary yes/no output, etc.). The output of each model can then be combined to form a composite or combined output. The combined output can then be used to determine if an event has occurred, for example, by comparing the combined output with a threshold value (e.g., an event threshold). The determination of the occurrence of an event can then be based on the comparison of the combined output with the threshold value.

As an example, the one or more first event models can include a plurality of multivariate models, each using a plurality of temperature features as described above. The output of the multivariate models can include a percentage likelihood of the occurrence of an event at the particular location at which each model is applied. The resulting output values can then be used in a function such as a simple multiplication, a weighted average, a voting scheme, or the like to provide a combined output. The resulting output can then be compared to a threshold to determine if an event has occurred. For example, a combined output indicating that there is greater than a fifty percent likelihood of an event at the particular location can be taken as an indication that the event has occurred at the location of interest.

In some embodiments, the one or more first event models can also comprise other types of models. In some embodiments, a machine learning approach comprises a logistic regression model. In some such embodiments, one or more temperature features can be used to determine if an event is present at one or more locations of interest. The machine learning approach can rely on a training data set that can be obtained from a test set-up or obtained based on actual temperature data from known events. The one or more temperature features in the training data set can then be used to train the one or more first event models using machine learning, including any supervised or unsupervised learning approach. For example, the one or more first event models can include or consist of a neural network, a Bayesian network, a decision tree, a logistical regression model, a normalized logistical regression model, or the like. In some embodiments, the one or more first event models can comprise a model developed using unsupervised learning techniques such a k-means clustering and the like.

In some embodiments, the one or more first event models can be developed and trained using a logistic regression model. As an example for training of a model used to determine the presence or absence of an event, the training of the model can begin with providing the one or more temperature features to the logistic regression model corresponding to one or more reference data sets in which event(s) are present. Additional reference data sets can be provided in which event(s) are not present. The one or more temperature features can be provided to the logistic regression model, and a first multivariate model can be determined using the one or more frequency domain features as inputs. The first multivariate model can define a relationship between a presence and an absence of the events.

Once the one or more first event models are trained, the one or more first event models can be used to determine the presence or absence of an event at one or more locations along the length 120, and the one or more events identified at 13 can be utilized at 17 to identify corresponding data for training the one or more event models. The temperature features determined for each location along the length 120 can be used with the one or more first event models. The output of the one or more first event models can provide an indication of the presence of an event at each location for which the temperature features are obtained. When the output indicates that an event has occurred at a given location, an output can be generated indicating the presence of the event. The process can be repeated along the length to provide an event profile, which can comprise an indication of the events at one or more locations along the length 120 being monitored.

In some embodiments, the event outputs from the one or more first event models can be presented as a profile along a length 120 on an output device. The outputs can be presented in the form of an event profile depicted along an axis with or without a schematic. The event profile can then be used to visualize the event locations, which can allow for various processes to be carried out.

The identification of the event at step 13 allows the second set of measurements of the second signal to be obtained and associated or labeled with the event. For example, DTS measurements and/or temperature features can be used to identify an event at a location along the length 120 being monitored. A second set of measurements such as acoustic measurements can then be taken and labeled as being associated with an identified event. The labeled data can then be used to train the one or more event models at 17, as described in more detail below. Obtaining the second set of measurements at step 15 can occur simultaneously with (or disparately from) obtaining the first set of measurements at step 11. For example, both sets of measurements can be detected at the same time. Once the event is identified using the first set of measurements, the second set of measurements can be stored with the event identification. Since some events are relatively constant, obtaining the first set of measurements can occur prior to or after obtaining the second set of measurements.

According to this disclosure, the one or more event models can be trained using a labeled data set, obtained from field or in situ data (i.e., from event locations identified at 13 from the first set of measurements of the first signal of field data) that is labeled using other instrumentation to identify the presence and/or extent of an event. In some embodiments, the one or more event models can be further trained using a labeled data set, which can be obtained using a test apparatus such as a test flow set-up and/or field data that is labeled using other instrumentation to identify the extent of an event. Using labeled data, the method of developing the one or more second or event models can include determining one or more frequency domain features from the acoustic signal for at least a portion of the data from the labeled data. The one or more frequency domain features can be obtained across the portion of length where the event occurs, which can be determined using the first event model or models. The event model can then be trained using the frequency domain features from the labeled data and/or the tests. The training of the event models at 17 can use machine learning, including any supervised or unsupervised learning approach. For example, the one or more event models can include or be a neural network, a Bayesian network, a decision tree, a logistical regression model, a normalized logistical regression model, k-means clustering or the like.

In some embodiments, the one or more event models can be developed and trained at 17 using a logistic regression model. As an example for training of a model used to determine the extent of an event, the training of the one or more event models at 17 can begin with providing one or more frequency domain features to the logistic regression model corresponding to one or more event tests where known event extents have been measured. Similarly, one or more frequency domain features can be provided to the logistic regression model corresponding to one or more tests where no event is present. A first multivariate model can be determined using the one or more frequency domain features as inputs. The first multivariate model can define a relationship between a presence and an absence of the event and/or event extent.

In the one or more event models, the multivariate model equations can use the frequency domain features or combinations or transformations thereof to determine when a specific event or event extent is present. The multivariate model can define a threshold, decision point, and/or decision boundary having any type of shapes such as a point, line, surface, or envelope between the presence and absence of the event or an event extent. In some embodiments, the multivariate model can be in the form of a polynomial, though other representations are also possible. When models such as neural networks are used, the thresholds can be based on node thresholds within the model. As noted herein, the multivariate model is not limited to two dimensions (e.g., two frequency domain features or two variables representing transformed values from two or more frequency domain features), and rather can have any number of variables or dimensions in defining the threshold between the presence or absence of the event and the specific event extents. Different multivariate models can be used for various events and/or event, and each multivariate model can rely on different frequency domain features or combinations or transformations of frequency domain features.

Whether a test system or in situ sensors are used to obtain data on the event extents, collectively referred to as “reference data”, one or more models can be developed for the determination of the event extents using the reference data. The model(s) can be developed by determining one or more frequency domain features from the acoustic signal for at least a portion of the reference data. The training of the model(s) can use machine learning, including any supervised or unsupervised learning approach. For example, one or more of the model(s) can be a neural network, a Bayesian network, a decision tree, a logistical regression model, a normalized logistical regression model, k-means clustering, or the like.

The one or more frequency domain features used in the one or more event models can include any frequency domain features noted hereinabove as well as combinations and transformations thereof. For example, In some embodiments, the one or more frequency domain features comprise a spectral centroid, a spectral spread, a spectral roll-off, a spectral skewness, an RMS band energy, a total RMS energy, a spectral flatness, a spectral slope, a spectral kurtosis, a spectral flux, a spectral autocorrelation function, combinations and/or transformations thereof, or any normalized variant thereof. In some embodiments, the one or more frequency domain features comprise a normalized variant of the spectral spread (NVSS) and/or a normalized variant of the spectral centroid (NVSC).

The output of the (trained) one or more event models can comprise an indication of the event location(s) and/or extent(s). For example, the presence of one or more additional events can be determined from the trained one or more event models. The resulting output can, in aspects, be compared to the output of the one or more first event models to allow the event location determination to be based both on the one or more first event models (e.g., using the temperature features) and the one or more trained event models (e.g., using the frequency domain features). In aspects, a final output can be a function of both the output from the one or more first event models and the one or more trained event models. In some embodiments, the outputs can be combined as a product, weighted product, ratio, or other mathematical combination. Other combinations can include voting schemes, thresholds, or the like to allow the outputs from both models to be combined. As an example, if the output from either model is zero, then the event identification at the location would also indicate that there is no event at the location. In this example, one model can indicate that an event is present, but the other model can indicate that no event is present. The final result can indicate that no event is present. When both models indicate that the event is present, the final combined output can provide a positive indication of the event at the location. It is noted that the output of the one or more trained event models can provide one or more indications of event extents (e.g., number of trespassers, amount of fluid ingress, etc.). While this output can be distinct from the output of the one or more first event models, the two outputs can be combined to improve the accuracy of the event location identification.

In aspects, a combined or hybrid approach to determining event extents at the one or more locations at which an event is identified is utilized. In these embodiments, the outputs of the one or more first event models and the one or more (trained) event models can be used together to help to determine or confirm the presence and/or extent of an event along the length 120 being monitored (e.g., about premises 101). In some embodiments, the outputs of the two models can be combined to form a final event presence and/or event extent determination.

Subsequent to the training of the one or more event models at 17, the one or more trained event models can use one or more frequency domain features in one or more trained event models to validate the identified one or more events and/or predict an extent of the event(s). For example, the one or more trained event models can be used to identify the event, to validate an event identified by the one or more first event models, and/or predict the extent of one or more event. For example, in embodiments, the method can comprise retraining the one or more first event models using the first set of measurements and the identification of the at least one additional event as inputs.

In some embodiments, the frequency domain features can be used with one or more trained event models to predict an extent of an event. The one or more trained event models can relate an event extent to one or more frequency domain features. In some embodiments, the trained one or more event models can accept one or more frequency domain features as inputs. In general, the frequency domain features are representative of feature at a particular location, for example, a distance resolution portion of the optical fiber 162 along the length 120, (e.g., the length of periphery of premises 101). The one or more trained event models can comprise one or more models configured to accept the frequency domain features as input(s) and provide an indication of the presence and/or extent of the event at one or more locations along the length 120. In some embodiments, the one or more trained event models can comprise a multivariate model, a machine learning model using supervised or unsupervised learning algorithms, or the like.

In some embodiments, the one or more event models can be developed using a machine learning approach. In some such embodiments, a single frequency domain feature (e.g., spectral flatness, RMS bin values, etc.) can be used to determine if the event is present at each location of interest. In some embodiments, the supervised learning approach can be used to determine a model of the event extent.

In some aspects, the event identification and corresponding reference data can be used to calibrate the one or more first event models. In this context, training the one or more event models can include a calibration process. For example, the models or structure of the model (e.g., the type of model, identification of the model variables, etc.) can be known or pre-trained, and the event identification and corresponding reference data can be used as a new training data set or used to supplement the original training data set to re-train or calibrate the one or more event models. This can allow one or more parameters (e.g., coefficients, weightings, etc.) to be updated or calibrated to provide a more accurate model. This process may be useful to calibrate existing models for specific applications to improve the event identifications in those locations.

The use of the event identification and reference data can allow for an event model to be trained using the event identification and reference data as the input data. An event model, may be defined by one or more frequency domain features and a relationship between or among the features. The event identification can be used to select the appropriate model (e.g., as defined by the identification and relationship of the one or more frequency domain features), and the reference data can be used to train the model to determine the model parameters (e.g., coefficients, weightings, etc.). This process can represent a calibration of the one or more event models rather than developing an entirely new model.

The in-situ identification of training data can also be used to cross-check and validate existing models. For example, the in-situ identified data can be used to train the one or more event models as described herein. When an additional event is identified using the trained one or more event models, the event identification can be used to identify additional data using the first signals, which would correspond to the first set of measurements. The first event models can be trained to verify whether or not the newly trained model matches the original model within a given threshold. When the models match, the system can provide an indication that the event is the only event present. When the models do not match, it can be an indication that another, unidentified event is present within the data. Additional training and event identification can then be used to identify the additional event. The cross-checking and validation process can be carried out using subsequent data in time, at locations along the optical fiber 162, and/or across different locations.

For example, DTS data can be used to identify an event. Corresponding DAS acoustic data can be obtained during the event, and the resulting reference data can be used to train one or more event models for the event using one or more frequency domain features obtained from the DAS data. The resulting event models using the one or more frequency domain features can then be used alone or in combination with the DTS models to identify an event. The DAS data can be used to identify an event using the trained event models. When an event is detected, additional data such as DTS data can be obtained. The training process can then be repeated using the DTS data to train an event model, and the resulting trained model can be compared to the original DTS model for event. If the models match within a threshold (e.g., within a margin of error, etc.), then the models can be understood to detect the event with reasonable certainty. However, if the models do not match, an additional event may be present. For example, the event as detected by the trained event model using the one or more frequency domain features may include multiple events. By training the model using the identified DTS data, the model may not match the original model due to the presence of additional events.

When the models do not match within a threshold or margin of error, the various data can be used to identify one or more events and identify any remaining noise or background signals. The remaining signals can then be attributed to a separate event that can be identified using other signatures, models, or processes. For example, additional information (from the same or additional sensors) can be used with the noise signals to identify additional data that can be used to train an additional one or more event models to capture the additional events.

Even when the original model and the additional model match within a margin of error, the process can be used to improve both sets of models. In some embodiments, once one or more event models are trained using the reference data, the one or more event models can be used to identify one or more events. Additional data using a signal that represents a different physical measurement, which can be the same as the first signal used to train the one or more event models, can be obtained and labeled using the identification of the event. The original thresholds, signatures, and/or models can then be retrained using the new reference data and/or a set of reference data supplemented by the new reference data (e.g., the original training data set and the new reference data combined to provide a larger training data set). This process can provide an improvement in the model output.

This process can be carried out at different locations, at different locations in different environments, and/or at different times in the same or different locations in the location or a separate location. This can allow for an improved reference data set (e.g., that is labeled with the identified events) that can be used to train the one or more event models over time to provide improved results for event identification.

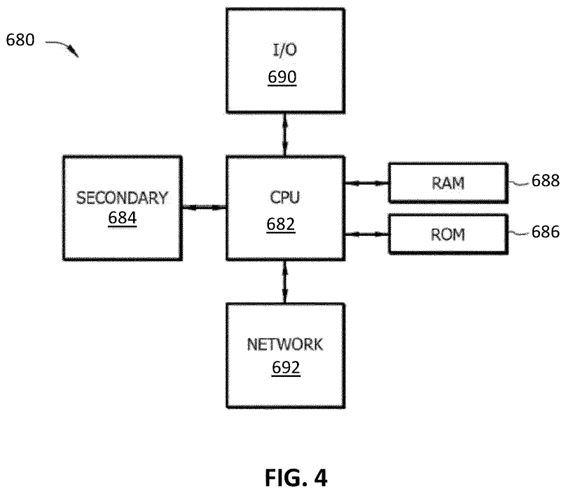

Subsequent to training the one or more event models, the one or more trained event models can be utilized alone or in conjunction with and/or the one or more first event models or other data. For example, subsequent training of one or more event models with DAS data in combination with the location of one or more events identified via DTS data, the one or more trained event models can be utilized alone or in combination with the one or more first event models to identify at least one additional event at the and/or another location. In applications, DAS and DTS can be combined as described, for example, in in PCT Patent Application No. PCT/EP2020/051817, entitled, “Event Characterization Using Hybrid DAS/DTS Measurements”, filed on Jan. 24, 2020, which is incorporated herein in its entirety. Any of the systems and methods disclosed herein can be carried out on a computer or other device comprising a processor (e.g., a desktop computer, a laptop computer, a tablet, a server, a smartphone, or some combination thereof), such as the acquisition device 160 of FIG. 3. FIG. 4 illustrates a computer system 680 suitable for implementing one or more embodiments disclosed herein such as the acquisition device or any portion thereof. The computer system 680 includes a processor 682 (which may be referred to as a central processor unit or CPU) that is in communication with memory devices including secondary storage 684, read only memory (ROM) 686, random access memory (RAM) 688, input/output (I/O) devices 690, and network connectivity devices 692. The processor 682 may be implemented as one or more CPU chips.

It is understood that by programming and/or loading executable instructions onto the computer system 680, at least one of the CPU 682, the RAM 688, and the ROM 686 are changed, transforming the computer system 680 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 680 is turned on or booted, the CPU 682 may execute a computer program or application. For example, the CPU 682 may execute software or firmware stored in the ROM 686 or stored in the RAM 688. In some cases, on boot and/or when the application is initiated, the CPU 682 may copy the application or portions of the application from the secondary storage 684 to the RAM 688 or to memory space within the CPU 682 itself, and the CPU 682 may then execute instructions of which the application is comprised. In some cases, the CPU 682 may copy the application or portions of the application from memory accessed via the network connectivity devices 692 or via the I/O devices 690 to the RAM 688 or to memory space within the CPU 682, and the CPU 682 may then execute instructions of which the application is comprised. During execution, an application may load instructions into the CPU 682, for example load some of the instructions of the application into a cache of the CPU 682. In some contexts, an application that is executed may be said to configure the CPU 682 to do something, e.g., to configure the CPU 682 to perform the function or functions promoted by the subject application. When the CPU 682 is configured in this way by the application, the CPU 682 becomes a specific purpose computer or a specific purpose machine.

The secondary storage 684 is typically comprised of one or more disk drives or tape drives and is used for non-volatile storage of data and as an over-flow data storage device if RAM 688 is not large enough to hold all working data. Secondary storage 684 may be used to store programs which are loaded into RAM 688 when such programs are selected for execution. The ROM 686 is used to store instructions and perhaps data which are read during program execution. ROM 686 is a non-volatile memory device which typically has a small memory capacity relative to the larger memory capacity of secondary storage 684. The RAM 688 is used to store volatile data and perhaps to store instructions. Access to both ROM 686 and RAM 688 is typically faster than to secondary storage 684. The secondary storage 684, the RAM 688, and/or the ROM 686 may be referred to in some contexts as computer readable storage media and/or non-transitory computer readable media.

I/O devices 690 may include printers, video monitors, electronic displays (e.g., liquid crystal displays (LCDs), plasma displays, organic light emitting diode displays (OLED), touch sensitive displays, etc.), keyboards, keypads, switches, dials, mice, track balls, voice recognizers, card readers, paper tape readers, or other well-known input devices.

The network connectivity devices 692 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 692 may enable the processor 682 to communicate with the Internet or one or more intranets. With such a network connection, it is contemplated that the processor 682 might receive information from the network, or might output information to the network (e.g., to an event database) in the course of performing the above-described method steps. Such information, which is often represented as a sequence of instructions to be executed using processor 682, may be received from and outputted to the network, for example, in the form of a computer data signal embodied in a carrier wave.

Such information, which may include data or instructions to be executed using processor 682 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several known methods. The baseband signal and/or signal embedded in the carrier wave may be referred to in some contexts as a transitory signal.

The processor 682 executes instructions, codes, computer programs, scripts which it accesses from hard disk, floppy disk, optical disk (these various disk based systems may all be considered secondary storage 684), flash drive, ROM 686, RAM 688, or the network connectivity devices 692. While only one processor 682 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 684, for example, hard drives, floppy disks, optical disks, and/or other device, the ROM 686, and/or the RAM 688 may be referred to in some contexts as non-transitory instructions and/or non-transitory information.

In an embodiment, the computer system 680 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 680 to provide the functionality of a number of servers that is not directly bound to the number of computers in the computer system 680. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third party provider. Some cloud computing environments may comprise cloud computing resources owned and operated by the enterprise as well as cloud computing resources hired and/or leased from a third party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 680, at least portions of the contents of the computer program product to the secondary storage 684, to the ROM 686, to the RAM 688, and/or to other non-volatile memory and volatile memory of the computer system 680. The processor 682 may process the executable instructions and/or data structures in part by directly accessing the computer program product, for example by reading from a CD-ROM disk inserted into a disk drive peripheral of the computer system 680. Alternatively, the processor 682 may process the executable instructions and/or data structures by remotely accessing the computer program product, for example by downloading the executable instructions and/or data structures from a remote server through the network connectivity devices 692. The computer program product may comprise instructions that promote the loading and/or copying of data, data structures, files, and/or executable instructions to the secondary storage 684, to the ROM 686, to the RAM 688, and/or to other non-volatile memory and volatile memory of the computer system 680.

In some contexts, the secondary storage 684, the ROM 686, and the RAM 688 may be referred to as a non-transitory computer readable medium or a computer readable storage media. A dynamic RAM embodiment of the RAM 688, likewise, may be referred to as a non-transitory computer readable medium in that while the dynamic RAM receives electrical power and is operated in accordance with its design, for example during a period of time during which the computer system 680 is turned on and operational, the dynamic RAM stores information that is written to it. Similarly, the processor 682 may comprise an internal RAM, an internal ROM, a cache memory, and/or other internal non-transitory storage blocks, sections, or components that may be referred to in some contexts as non-transitory computer readable media or computer readable storage media.

Also disclosed herein is a system for identifying events. In embodiments, the system comprises: a memory (e.g., RAM 688, ROM 686); an identification program stored in the memory; and a processor 682, wherein the identification program, when executed on the processor 682, configures the processor 682 to: receive a first set of measurements comprising a first signal of field data at a location; identify one or more events at the location using the first set of measurements; receive a second set of measurements comprising a second signal at the location, wherein the first signal and the second signal represent at least one different physical measurements; train one or more event models using the second set of measurements and the identification of the one or more events as inputs; and use the one or more event models to identify at least one additional event at one or more locations. In aspects, as described hereinabove, the second set of measurements comprises acoustic measurements obtained at the location.

As discussed hereinabove, the one or more events can comprise a security event, a transportation event, a geothermal event, a facility monitoring event, a pipeline monitoring event, a dam monitoring event, or any combination thereof. The first set of measurements can be received from at least one of a temperature sensor, a flow meter, a pressure sensor, a strain sensor, a position sensor, a current meter, or any combination thereof. The first set of measurements and the second set of measurements can be from a same time interval or from different time intervals.

The processor 682 can be further configured to: create labeled data using the identified one or more events and the second set of measurements. Alternatively or additionally, the processor 682 can be further configured to: use the first set of measurements with one or more first event models; and identify the one or more events with the one or more first event models. Alternatively or additionally, the processor 682 can be further configured to: retrain the one or more first event models using the first set of measurements and the identification of the at least one additional event as inputs. Alternatively or additionally, the processor 682 can be further configured to: monitor the first signal at the location; monitor the second signal at the location; use the first signal in the one or more first event models; use the second signal in the one or more event models; and detect the at least one additional event based on outputs of both the one or more first event models and the one or more event models. In aspects, the processor 682 is configured to train the one or more event models by calibrating the one or more event models using the second set of measurements and the identification of the one or more events as inputs. Alternatively or additionally, the processor 682 is further configured to: obtain a third set of measurements comprising a third signal, wherein each of the first signal, the second signal, and the third signal represent at least one different physical measurement; train one or more third event models using the third set of measurements and at least one of: 1) the identification of the one or more events, or 2) the identification of the at least one additional event, as inputs; and use the one or more third event models to identify at least one third event at the one or more locations.

In aspects, as detailed above with reference to FIG. 1B, the first set of measurements comprise an acoustic data set. In such embodiments, the system comprises: a memory (e.g., RAM 688, ROM 686); an identification program stored in the memory; and a processor 682, wherein the identification program, when executed on the processor 682, configures the processor 682 to: receive a first set of measurements comprising a first signal of field data at a location; identify one or more events at the location using the first set of measurements; obtain an acoustic data set at the location, wherein the first signal is not an acoustic signal; train one or more event models using the acoustic data set and the identification of the one or more events as inputs; and use the trained one or more event models to identify at least one additional event at the location or a second location. The first set of measurements can comprise temperature measurements.

The processor 682 can be further configured to: identify a first event at the location using one or more first event models. The processor 682 can be configured to train the one or more event models by: obtaining acoustic data for the location from the acoustic data set; and training the one or more event models using the acoustic data for the location and the identification of the first event at the location. The processor 682 can be configured to use the trained one or more event models to identify the at least one additional event by using the one or more trained event models to identify the at least one additional event at a second location.

In aspects, as detailed above with reference to FIG. 1C, the first set of measurements comprise a first signal of field data across a plurality of locations. In such embodiments, the system can comprise: a memory (e.g., RAM 688, ROM 686); an identification program stored in the memory; and a processor 682, wherein the identification program, when executed on the processor 682, configures the processor 682 to: receive a first set of measurements comprising a first signal of field data across a plurality of locations; identify one or more events at one or more locations of the plurality of locations using the first set of measurements; obtain a second set of measurements comprising a second signal across the plurality of locations, wherein the first signal and the second signal represent at least one different physical measurements; train one or more event models using the second set of measurements at the one or more locations of the plurality of locations and the identification of the one or more events as inputs; and use the one or more event models to identify at least one additional event across the plurality of locations. Training the one or more event models can comprise: training one or more first event models of the one or more event models using the second set of measurements at a first location of the one or more locations and the identification of the one or more events at the first location as inputs; training one or more second event models of the one of the one or more event models using the second set of measurements at a second location of the one or more locations and the identification of the one or more events at the second location as inputs; comparing the one or more first event models and the one or more second event models; and determining the one or more event models based on the comparison of the one or more first event models and the one or more second event models. The processor 682 can be configured to train the one or more event models by: training the one or more event models using the second set of measurements from a plurality of locations of the one or more locations and the identification of the one or more events at the plurality of locations as inputs. Training the one or more event models can comprise: training one or more first event models of the one or more event models using the second set of measurements at a first location of the one or more locations at a first time and the identification of the one or more events at the first location as inputs; retraining the one or more first event models of the one or more event models using the second set of measurements at the first location of the one or more locations at a second time and the identification of the one or more events at the first location as inputs; comparing the trained one or more first event models and the retrained one or more first event models; and determining the one or more event models based on the comparison of the trained one or more first event models and the retrained one or more first event models.

As detailed hereinabove, a first set of measurements can be utilized to train one or more event models operable with a second set of measurements. Utilizing local data as reference for training the one or more event models can simplify the use of the one or more event models and subsequently (i.e., after training the one or more event models), the trained one or more event models can be utilized alone or in conjunction with the first set of measurements (e.g., with one or more first event models therefor) to identify at least one additional event at the or another location. In aspects, the trained one or more event models can be utilized in conjunction with the first set of measurements (e.g., with one or more first event models therefor) to provide additional information beyond information either the one or more event models or the one or more first event models can provide independently, and/or to provide validation of the outputs from the one or more event models and/or the one or more first event models. For example, when the first set of measurements comprises DTS data and the second set of measurements comprises DAS data, the one or more event models can be trained using the second set of measurements and the identification of the one or more events provided by the first set of measurements, and subsequently, the one or more trained event models can be utilized to determine the presence or absence of an event where the one or more first event models (e.g., the DTS data) cannot alone specify the event. The system and method of identifying events as disclosed herein can thus be utilized to provide more information than can typically be provided by the one or more first event models and/or the one or more event models alone, and/or can be utilized to build confidence in the outputs thereof.

Having described various systems and methods, certain aspects can include, but are not limited to:

In a first aspect, a method of identifying events comprises: identifying one or more events at a location; obtaining a first set of measurements comprising a first signal at the location; training one or more event models using the second set of measurements and the identification of the one or more events as inputs; and using the one or more event models to identify at least one additional event at one or more locations.

A second aspect can include the method of the first aspect, further comprising: obtaining a second set of measurements comprising a second signal at the location, wherein identifying the one or more events at the location comprises identifying the one or more events at the location using the second set of measurements, and wherein the first signal and the second signal represent different physical measurements.

A third aspect can include the method of the first or second aspect, wherein identifying the one or more events at the location comprises using an identity of the one or more events based on a known event or induced event at the location.

A fourth aspect can include the method of any one of the first to third aspects, wherein the first set of measurements comprises acoustic measurements obtained at the location.

A fifth aspect can include the method of any one of the first to fourth aspects, wherein the one or more events comprise a security event, a transportation event, a geothermal event, a facility monitoring event, a pipeline monitoring event, a dam monitoring event, or any combination thereof.

A sixth aspect can include the method of any one of the second to fifth aspects, wherein the second set of measurements comprise at least one of a temperature sensor measurement, a flow meter measurement, a pressure sensor measurement, a strain sensor measurement, a position sensor measurement, a current meter measurement, a level sensor measurement, a phase sensor measurement, a composition sensor measurement, an optical sensor measurement, an image sensor measurement, or any combination thereof.

A seventh aspect can include the method of any one of the first to sixth aspects, further comprising: creating labeled data using the identified one or more events and the first set of measurements.

An eighth aspect can include the method of any one of the second to seventh aspects, wherein the first set of measurements and the second set of measurements are obtained simultaneously.

A ninth aspect can include the method of any one of the second to seventh aspects, wherein the first set of measurements and the second set of measurements are obtained at different time intervals.

A tenth aspect can include the method of any one of the second to ninth aspects, wherein identifying the one or more events comprises: using the second set of measurements with one or more first event models; and identifying the one or more events with the one or more first event models.

An eleventh aspect can include the method of the tenth aspect, further comprising: retraining the one or more event models using the second set of measurements and the identification of the at least one additional event as inputs.

A twelfth aspect can include the method of the tenth or eleventh aspect, further comprising: monitoring the first signal at the location; monitoring the second signal at the location; using the second signal in the one or more first event models; using the first signal in the one or more event models; and detecting the at least one additional event based on outputs of both the one or more first event models and the one or more event models.

A thirteenth aspect can include the method of any one of the first to twelfth aspects, wherein training the one or more event models comprises calibrating the one or more event models using the first set of measurements and the identification of the one or more events as inputs.

A fourteenth aspect can include the method of any one of the second to thirteenth aspects, further comprising: obtaining a third set of measurements comprising a third signal, wherein each of the first signal, the second signal, and the third signal represent at least one different physical measurement; training one or more third event models using the third set of measurements and at least one of: 1) the identification of the one or more events, or 2) the identification of the at least one additional event, as inputs; and using the one or more third event models to identify at least one third event at the one or more locations.

A fifteenth aspect can include the method of any one of the first to fourteenth aspects, wherein the one or more event models are one or more pre-trained event models, and wherein training the one or more event models using the first set of measurements and the identification of the one or more events as inputs comprises: calibrating the one or more pre-trained event models using the first set of measurements and the identification of the one or more events as inputs; and updating at least one parameter of the one or more pre-trained event models in response to the calibrating.

A sixteenth aspect can include the method of any one of the first to fourteenth aspects, further comprising: obtaining a third set of measurements comprising a third signal, wherein the third signal and the second signal represent different physical measurements, and wherein the third set of measurements represent the at least one additional event; and training one or more additional event models using the third set of measurements and the identification of the at least one additional event as inputs.

A seventeenth aspect can include the method of the sixteenth aspect, wherein identifying the one or more events using the first set of measurements comprises: using the one or more additional event models to identify the one or more events, and wherein training the one or more additional event models using the third set of measurements and the identification of the at least one additional event as inputs comprises: retaining the one or more additional event models using the third set of measurements and the identification of the at least one additional event as inputs.

In an eighteenth aspect, a system for identifying events comprises: a memory; an identification program stored in the memory; and a processor, wherein the identification program, when executed on the processor, configures the processor to: identify one or more events at a location; receive a first set of measurements comprising a first signal at the location; train one or more event models using the first set of measurements and the identification of the one or more events as inputs; and use the one or more event models to identify at least one additional event at one or more locations.

A nineteenth aspect can include the system of the eighteenth aspect, wherein the identification program further configures the processor to: receive a second set of measurements comprising a second signal, wherein the identification of the one or more events at the location comprises an identification of the one or more events at the location based on the second set of measurements, and wherein the first signal and the second signal represent different physical measurements.

A twentieth aspect can include the system of the eighteenth or nineteenth aspect, wherein the identification of the one or more events at the location comprises receiving an identity of the one or more events based on a known event or induced event at the location.

A twenty first aspect can include the system of any one of the eighteenth to twentieth aspects, wherein the first set of measurements comprises acoustic measurements obtained at the location.

A twenty second aspect can include the system of any one of the eighteenth to twenty first aspects, wherein the one or more events comprise a security event, a transportation event, a geothermal event, a facility monitoring event, a pipeline monitoring event, a dam monitoring event, or any combination thereof.

A twenty third aspect can include the system of any one of the eighteenth to twenty second aspects, wherein the first set of measurements are received from at least one of a temperature sensor, a flow meter, a pressure sensor, a strain sensor, a position sensor, a current meter, a level sensor, a phase sensor, a composition sensor, an optical sensor, an image sensor, or any combination thereof.

A twenty fourth aspect can include the system of any one of the eighteenth to twenty second aspects, wherein the processor is further configured to: create labeled data using the identified one or more events and the first set of measurements.

A twenty fifth aspect can include the system of any one of the eighteenth to twenty fourth aspects, wherein the first set of measurements and the second set of measurements are from a same time interval.

A twenty sixth aspect can include the system of any one of the eighteenth to twenty fourth aspects, wherein the first set of measurements and the second set of measurements are from different time intervals.

A twenty seventh aspect can include the system of any one of the eighteenth to twenty sixth aspects, wherein the processor is further configured to: use the second set of measurements with one or more first event models; and identify the one or more events with the one or more second event models.

A twenty eighth aspect can include the system of the twenty seventh aspect, wherein the processor is further configured to: retrain the one or more first event models using the second set of measurements and the identification of the at least one additional event as inputs.

A twenty ninth aspect can include the system of the twenty seventh or twenty eighth aspect, wherein the processor is further configured to: monitor the first signal at the location; monitor the second signal at the location; use the second signal in the one or more first event models; use the first signal in the one or more event models; and detect the at least one additional event based on outputs of both the one or more first event models and the one or more event models.

A thirtieth aspect can include the system of any one of the eighteenth to twenty ninth aspects, wherein the processor is configured to train the one or more event models by calibrating the one or more event models using the first set of measurements and the identification of the one or more events as inputs.

A thirty first aspect can include the system of any one of the eighteenth to thirtieth aspects, wherein the processor is further configured to: obtain a third set of measurements comprising a third signal, wherein each of the first signal, the second signal, and the third signal represent at least one different physical measurement; train one or more third event models using the third set of measurements and at least one of: 1) the identification of the one or more events, or 2) the identification of the at least one additional event, as inputs; and use the one or more third event models to identify at least one third event at the one or more locations.

A thirty second aspect can include the system of any one of the eighteenth to thirty first aspects, wherein the one or more event models are one or more pre-trained event models, and wherein the processor is further configured to: calibrate the one or more pre-trained event models using the first set of measurements and the identification of the one or more events as inputs; and update at least one parameter of the one or more pre-trained event models in response to the calibrating.

In a thirty third aspect, a method of identifying events comprises: obtaining a first set of measurements comprising a first signal of field data at a location; identifying one or more events at the location using the first set of measurements; obtaining an acoustic data set at the location, wherein the first signal is not an acoustic signal; training one or more event models using the acoustic data set and the identification of the one or more events as inputs; and using the trained one or more event models to identify at least one additional event at the location or a second location.

A thirty fourth aspect can include the method of the thirty third aspect, wherein the first set of measurements comprises temperature measurements.

A thirty fifth aspect can include the method of the thirty third or thirty fourth aspect, wherein identifying the one or more events at the location comprises: identifying a first event at the location using one or more first event models.

A thirty sixth aspect can include the method of the thirty fifth aspect, wherein training the one or more event models comprises: obtaining acoustic data for the location from the acoustic data set; and training the one or more event models using the acoustic data for the location and the identification of the first event at the location.

A thirty seventh aspect can include the method of the thirty sixth aspect, wherein using the trained one or more event models to identify the at least one additional event comprises using the one or more trained event models to identify the at least one additional event at a second location.

In a thirty eighth aspect, a system for identifying events comprises: a memory; an identification program stored in the memory; and a processor, wherein the identification program, when executed on the processor, configures the processor to: receive a first set of measurements comprising a first signal of field data at a location; identify one or more events at the location using the first set of measurements; obtain an acoustic data set at the location, wherein the first signal is not an acoustic signal; train one or more event models using the acoustic data set and the identification of the one or more events as inputs; and use the trained one or more event models to identify at least one additional event at the location or a second location.

A thirty ninth aspect can include the system of the thirty eighth aspect, wherein the first set of measurements comprises temperature measurements.

A fortieth aspect can include the system of the thirty eighth or thirty ninth aspect, wherein the processor is further configured to: identify a first event at the location using one or more first event models.

A forty first aspect can include the system of the fortieth aspect, wherein the processor is configured to train the one or more event models by: obtaining acoustic data for the location from the acoustic data set; and training the one or more event models using the acoustic data for the location and the identification of the first event at the location.

A forty second aspect can include the system of the forty first aspect, wherein the processor is configured to use the trained one or more event models to identify the at least one additional event by using the one or more trained event models to identify the at least one additional event at a second location.

In a forty third aspect, a method of identifying events comprises: obtaining a first set of measurements comprising a first signal of field data across a plurality of locations; identifying one or more events at one or more locations of the plurality of locations using the first set of measurements; obtaining a second set of measurements comprising a second signal across the plurality of locations, wherein the first signal and the second signal represent at least one different physical measurements; training one or more event models using the second set of measurements at the one or more locations of the plurality of locations and the identification of the one or more events as inputs; and using the one or more event models to identify at least one additional event across the plurality of locations.

A forty fourth aspect can include the method of the forty third aspect, wherein training the one or more event models comprises: training one or more first event models of the one or more event models using the second set of measurements at a first location of the one or more locations and the identification of the one or more events at the first location as inputs; training one or more second event models of the one of the one or more event models using the second set of measurements at a second location of the one or more locations and the identification of the one or more events at the second location as inputs; comparing the one or more first event models and the one or more second event models; and determining the one or more event models based on the comparison of the one or more first event models and the one or more second event models.

A forty fifth aspect can include the method of the forty third or forty fourth aspect, wherein training the one or more event models comprises: training the one or more event models using the second set of measurements from a plurality of locations of the one or more locations and the identification of the one or more events at the plurality of locations as inputs.

A forty sixth aspect can include the method of the forty third or forty fourth aspect, wherein training the one or more event models comprises: training one or more first event models of the one or more event models using the second set of measurements at a first location of the one or more locations at a first time and the identification of the one or more events at the first location as inputs; retraining the one or more first event models of the one or more event models using the second set of measurements at the first location of the one or more locations at a second time and the identification of the one or more events at the first location as inputs; comparing the trained one or more first event models and the retrained one or more first event models; and determining the one or more event models based on the comparison of the trained one or more first event models and the retrained one or more first event models.

In a forty seventh aspect, a system for identifying events comprises: a memory; an identification program stored in the memory; and a processor, wherein the identification program, when executed on the processor, configures the processor to: receive a first set of measurements comprising a first signal of field data across a plurality of locations; identify one or more events at one or more locations of the plurality of locations using the first set of measurements; obtain a second set of measurements comprising a second signal across the plurality of locations, wherein the first signal and the second signal represent at least one different physical measurements; train one or more event models using the second set of measurements at the one or more locations of the plurality of locations and the identification of the one or more events as inputs; and use the one or more event models to identify at least one additional event across the plurality of locations.

A forty eighth aspect can include the system of the forty seventh aspect, wherein training the one or more event models comprises: training one or more first event models of the one or more event models using the second set of measurements at a first location of the one or more locations and the identification of the one or more events at the first location as inputs; training one or more second event models of the one of the one or more event models using the second set of measurements at a second location of the one or more locations and the identification of the one or more events at the second location as inputs; comparing the one or more first event models and the one or more second event models; and determining the one or more event models based on the comparison of the one or more first event models and the one or more second event models.

A forty ninth aspect can include the system of the forty seventh or forty eighth aspect, wherein the processor is configured to train the one or more event models by: training the one or more event models using the second set of measurements from a plurality of locations of the one or more locations and the identification of the one or more events at the plurality of locations as inputs.

A fiftieth aspect can include the system of the forty seventh or forty eighth aspect, wherein training the one or more event models comprises: training one or more first event models of the one or more event models using the second set of measurements at a first location of the one or more locations at a first time and the identification of the one or more events at the first location as inputs; retraining the one or more first event models of the one or more event models using the second set of measurements at the first location of the one or more locations at a second time and the identification of the one or more events at the first location as inputs; comparing the trained one or more first event models and the retrained one or more first event models; and determining the one or more event models based on the comparison of the trained one or more first event models and the retrained one or more first event models.

While exemplary embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

1. A method of identifying events, the method comprising:
identifying one or more events at a location;
obtaining a first set of measurements comprising a first signal at the location;
training one or more event models using the second set of measurements and the identification of the one or more events as inputs; and
using the one or more event models to identify at least one additional event at one or more locations.

2. The method of claim 1, further comprising:
obtaining a second set of measurements comprising a second signal at the location, wherein identifying the one or more events at the location comprises identifying the one or more events at the location using the second set of measurements, and wherein the first signal and the second signal represent different physical measurements.

3. The method of claim 1, wherein identifying the one or more events at the location comprises using an identity of the one or more events based on a known event or induced event at the location.

4. The method of claim 1, wherein the first set of measurements comprises acoustic measurements obtained at the location.

5. The method of claim 1, wherein the one or more events comprise a security event, a transportation event, a geothermal event, a facility monitoring event, a pipeline monitoring event, a dam monitoring event, or any combination thereof.

6. The method of claim 1, wherein the second set of measurements comprise at least one of a temperature sensor measurement, a flow meter measurement, a pressure sensor measurement, a strain sensor measurement, a position sensor measurement, a current meter measurement, a level sensor measurement, a phase sensor measurement, a composition sensor measurement, an optical sensor measurement, an image sensor measurement, or any combination thereof.

7. The method of claim 1, further comprising:
creating labeled data using the identified one or more events and the first set of measurements.

8. The method of claim 2, wherein the first set of measurements and the second set of measurements are obtained simultaneously.

9. The method of claim 2, wherein the first set of measurements and the second set of measurements are obtained at different time intervals.

10. The method of claim 2, wherein identifying the one or more events comprises:
using the second set of measurements with one or more first event models; and
identifying the one or more events with the one or more first event models.

11. The method of claim 10, further comprising:
retraining the one or more event models using the second set of measurements and the identification of the at least one additional event as inputs.

12. The method of claim 10, further comprising:
monitoring the first signal at the location;
monitoring the second signal at the location;
using the second signal in the one or more first event models;
using the first signal in the one or more event models; and
detecting the at least one additional event based on outputs of both the one or more first event models and the one or more event models.

13. The method of claim 1, wherein training the one or more event models comprises calibrating the one or more event models using the first set of measurements and the identification of the one or more events as inputs.

14. The method of claim 2, further comprising:
obtaining a third set of measurements comprising a third signal, wherein each of the first signal, the second signal, and the third signal represent at least one different physical measurement;
training one or more third event models using the third set of measurements and at least one of: 1) the identification of the one or more events, or 2) the identification of the at least one additional event, as inputs; and
using the one or more third event models to identify at least one third event at the one or more locations.

15. The method of claim 1, wherein the one or more event models are one or more pre-trained event models, and wherein training the one or more event models using the first set of measurements and the identification of the one or more events as inputs comprises:
calibrating the one or more pre-trained event models using the first set of measurements and the identification of the one or more events as inputs; and
updating at least one parameter of the one or more pre-trained event models in response to the calibrating.

16. The method of claim 1, further comprising:
obtaining a third set of measurements comprising a third signal, wherein the third signal and the second signal represent different physical measurements, and wherein the third set of measurements represent the at least one additional event; and
training one or more additional event models using the third set of measurements and the identification of the at least one additional event as inputs.

17. The method of claim 16, wherein identifying the one or more events using the first set of measurements comprises: using the one or more additional event models to identify the one or more events, and wherein training the one or more additional event models using the third set of measurements and the identification of the at least one additional event as inputs comprises: retaining the one or more additional event models using the third set of measurements and the identification of the at least one additional event as inputs.

18. A system for identifying events, the system comprising:
a memory;
an identification program stored in the memory; and
a processor, wherein the identification program, when executed on the processor, configures the processor to:
identify one or more events at a location;
receive a first set of measurements comprising a first signal at the location;
train one or more event models using the first set of measurements and the identification of the one or more events as inputs; and
use the one or more event models to identify at least one additional event at one or more locations.

19. The system of claim 18, wherein the identification program further configures the processor to:
receive a second set of measurements comprising a second signal, wherein the identification of the one or more events at the location comprises an identification of the one or more events at the location based on the second set of measurements, and wherein the first signal and the second signal represent different physical measurements.

20. The system of claim 18, wherein the identification of the one or more events at the location comprises receiving an identity of the one or more events based on a known event or induced event at the location.

21. The system of claim 18, wherein the first set of measurements comprises acoustic measurements obtained at the location.

22. The system of claim 18, wherein the one or more events comprise a security event, a transportation event, a geothermal event, a facility monitoring event, a pipeline monitoring event, a dam monitoring event, or any combination thereof.

23. The system of claim 18, wherein the first set of measurements are received from at least one of a temperature sensor, a flow meter, a pressure sensor, a strain sensor, a position sensor, a current meter, a level sensor, a phase sensor, a composition sensor, an optical sensor, an image sensor, or any combination thereof.

24. The system of claim 18, wherein the processor is further configured to:
create labeled data using the identified one or more events and the first set of measurements.

25. The system of claim 18, wherein the first set of measurements and the second set of measurements are from a same time interval.

26. The system of claim 18, wherein the first set of measurements and the second set of measurements are from different time intervals.

27. The system of claim 18, wherein the processor is further configured to:
use the second set of measurements with one or more first event models; and
identify the one or more events with the one or more second event models.

28. The system of claim 27, wherein the processor is further configured to:
retrain the one or more first event models using the second set of measurements and the identification of the at least one additional event as inputs.

29. The system of claim 27, wherein the processor is further configured to:
monitor the first signal at the location;
monitor the second signal at the location;
use the second signal in the one or more first event models;
use the first signal in the one or more event models; and
detect the at least one additional event based on outputs of both the one or more first event models and the one or more event models.

30. The system of claim 18, wherein the processor is configured to train the one or more event models by calibrating the one or more event models using the first set of measurements and the identification of the one or more events as inputs.

31. The system of claim 18, wherein the processor is further configured to:
obtain a third set of measurements comprising a third signal, wherein each of the first signal, the second signal, and the third signal represent at least one different physical measurement;
train one or more third event models using the third set of measurements and at least one of: 1) the identification of the one or more events, or 2) the identification of the at least one additional event, as inputs; and
use the one or more third event models to identify at least one third event at the one or more locations.

32. The system of claim 18, wherein the one or more event models are one or more pre-trained event models, and wherein the processor is further configured to:
calibrate the one or more pre-trained event models using the first set of measurements and the identification of the one or more events as inputs; and
update at least one parameter of the one or more pre-trained event models in response to the calibrating.

33. A method of identifying events, the method comprising:
obtaining a first set of measurements comprising a first signal of field data at a location;
identifying one or more events at the location using the first set of measurements;
obtaining an acoustic data set at the location, wherein the first signal is not an acoustic signal;
training one or more event models using the acoustic data set and the identification of the one or more events as inputs; and
using the trained one or more event models to identify at least one additional event at the location or a second location.

34. The method of claim 33, wherein the first set of measurements comprises temperature measurements.

35. The method claim 33, wherein identifying the one or more events at the location comprises:
identifying a first event at the location using one or more first event models.

36. The method of claim 35, wherein training the one or more event models comprises:
obtaining acoustic data for the location from the acoustic data set; and
training the one or more event models using the acoustic data for the location and the identification of the first event at the location.

37. The method of claim 36, wherein using the trained one or more event models to identify the at least one additional event comprises using the one or more trained event models to identify the at least one additional event at a second location.

38. A system for identifying events, the system comprising:
a memory;
an identification program stored in the memory; and
a processor, wherein the identification program, when executed on the processor, configures the processor to:
receive a first set of measurements comprising a first signal of field data at a location;
identify one or more events at the location using the first set of measurements;
obtain an acoustic data set at the location, wherein the first signal is not an acoustic signal;
train one or more event models using the acoustic data set and the identification of the one or more events as inputs; and
use the trained one or more event models to identify at least one additional event at the location or a second location.

39. The system of claim 38, wherein the first set of measurements comprises temperature measurements.

40. The system of claim 38, wherein the processor is further configured to:
identify a first event at the location using one or more first event models.

41. The system of claim 40, wherein the processor is configured to train the one or more event models by:
obtaining acoustic data for the location from the acoustic data set; and
training the one or more event models using the acoustic data for the location and the identification of the first event at the location.

42. The system of claim 41, wherein the processor is configured to use the trained one or more event models to identify the at least one additional event by using the one or more trained event models to identify the at least one additional event at a second location.

43. A method of identifying events, the method comprising:
obtaining a first set of measurements comprising a first signal of field data across a plurality of locations;
identifying one or more events at one or more locations of the plurality of locations using the first set of measurements;
obtaining a second set of measurements comprising a second signal across the plurality of locations, wherein the first signal and the second signal represent at least one different physical measurements;
training one or more event models using the second set of measurements at the one or more locations of the plurality of locations and the identification of the one or more events as inputs; and
using the one or more event models to identify at least one additional event across the plurality of locations.

44. The method of claim 43, wherein training the one or more event models comprises:
training one or more first event models of the one or more event models using the second set of measurements at a first location of the one or more locations and the identification of the one or more events at the first location as inputs;
training one or more second event models of the one of the one or more event models using the second set of measurements at a second location of the one or more locations and the identification of the one or more events at the second location as inputs;
comparing the one or more first event models and the one or more second event models; and
determining the one or more event models based on the comparison of the one or more first event models and the one or more second event models.

45. The method of claim 43, wherein training the one or more event models comprises:
training the one or more event models using the second set of measurements from a plurality of locations of the one or more locations and the identification of the one or more events at the plurality of locations as inputs.

46. The method of claim 43, wherein training the one or more event models comprises:
training one or more first event models of the one or more event models using the second set of measurements at a first location of the one or more locations at a first time and the identification of the one or more events at the first location as inputs;
retraining the one or more first event models of the one or more event models using the second set of measurements at the first location of the one or more locations at a second time and the identification of the one or more events at the first location as inputs;
comparing the trained one or more first event models and the retrained one or more first event models; and
determining the one or more event models based on the comparison of the trained one or more first event models and the retrained one or more first event models.

47. A system for identifying events, the system comprising:
a memory;
an identification program stored in the memory; and
a processor, wherein the identification program, when executed on the processor, configures the processor to:
receive a first set of measurements comprising a first signal of field data across a plurality of locations;
identify one or more events at one or more locations of the plurality of locations using the first set of measurements;
obtain a second set of measurements comprising a second signal across the plurality of locations, wherein the first signal and the second signal represent at least one different physical measurements;
train one or more event models using the second set of measurements at the one or more locations of the plurality of locations and the identification of the one or more events as inputs; and
use the one or more event models to identify at least one additional event across the plurality of locations.

48. The system of claim 47, wherein training the one or more event models comprises:
training one or more first event models of the one or more event models using the second set of measurements at a first location of the one or more locations and the identification of the one or more events at the first location as inputs;
training one or more second event models of the one of the one or more event models using the second set of measurements at a second location of the one or more locations and the identification of the one or more events at the second location as inputs;
comparing the one or more first event models and the one or more second event models; and
determining the one or more event models based on the comparison of the one or more first event models and the one or more second event models.

49. The system of claim 47, wherein the processor is configured to train the one or more event models by:
training the one or more event models using the second set of measurements from a plurality of locations of the one or more locations and the identification of the one or more events at the plurality of locations as inputs.

50. The system of claim 47, wherein training the one or more event models comprises:
training one or more first event models of the one or more event models using the second set of measurements at a first location of the one or more locations at a first time and the identification of the one or more events at the first location as inputs;
retraining the one or more first event models of the one or more event models using the second set of measurements at the first location of the one or more locations at a second time and the identification of the one or more events at the first location as inputs;
comparing the trained one or more first event models and the retrained one or more first event models; and
determining the one or more event models based on the comparison of the trained one or more first event models and the retrained one or more first event models.
